(19) United States
(12) Patent Application Publication
(10) Pub. No.: US 2013/0262483 A1
(43) Pub. Date: Oct. 3, 2013

(54) METHOD AND APPARATUS FOR PROVIDING INTELLIGENT PROCESSING OF CONTEXTUAL INFORMATION

(71) Applicants: Jan Otto Blom, Lutry (CH); Juha Kalevi Laurila, St-Legier (CH); Julian Charles Nolan, Pully (CH); Nikolai Nefedov, Gattikon (CH)

(72) Inventors: Jan Otto Blom, Lutry (CH); Juha Kalevi Laurila, St-Legier (CH); Julian Charles Nolan, Pully (CH); Nikolai Nefedov, Gattikon (CH)

(73) Assignee: Nokia Corporation, Espoo (FI)

(21) Appl. No.: 13/435,797

(22) Filed: Mar. 30, 2012

(51) Int. Cl. G06F 17/30

(52) U.S. Cl. 707/752; 707/736; 707/E17.009; 707/E17.058

(57) ABSTRACT

An approach is provided for providing intelligent processing of contextual information. An context platform determines at least one feature based, at least in part, on one or more contextual parameters The context platform further processes one or more contextual records to determine whether the at least one feature is a feature anchor based, at least in part, on whether the at least feature is represented above at least one threshold level. The context platform also processes the one or more contextual records to determine at least one profile for the at least one feature anchor.

### BACKGROUND

Service providers and device manufacturers (e.g., wireless, cellular, etc.) are continually challenged to deliver value and convenience to consumers by, for example, providing compelling network services. Device manufacturers have developed devices that allow for the collection of contextual information about the device's and/or user's environment, user's preferences, and the user's behavior. The ability of modern devices to collect this contextual information has led to service providers and device manufacturers finding different solutions or services that may be provided based on the information. However, to effectively use the contextual information, the information must be properly organized, continuously updated, and dynamically processed. The collection of the information must also be balanced with problems associated with resource consumption restraints for collecting the information using mobile devices, the fusion of features in real time to gain context-dependent information, and dynamically using the information. Accordingly, service providers and device manufacturers face significant challenges in providing ways for the collection, processing, and use of contextual information, particularly at a mobile device.

### SOME EXAMPLE EMBODIMENTS

Therefore, there is a need for an approach for providing intelligent processing of contextual information.

According to one embodiment, a method comprises determining at least one feature based, at least in part, on one or more contextual parameters. The method also comprises processing and/or facilitating a processing of one or more contextual records to determine whether the at least one feature is a feature anchor based, at least in part, on whether the at least feature is represented above at least one threshold level. The method also comprises processing and/or facilitating a processing of the one or more contextual records to determine at least one profile for the at least one feature anchor.

According to another embodiment, an apparatus comprises at least one processor, and at least one memory including computer program code for one or more computer programs, the at least one memory and the computer program code configured to, with the at least one processor, cause, at least in part, the apparatus to determine at least one feature based, at least in part, on one or more contextual parameters. The apparatus is also caused to process and/or facilitate a processing of one or more contextual records to determine whether the at least one feature is a feature anchor based, at least in part, on whether the at least feature is represented above at least one threshold level. The apparatus is also caused to process and/or facilitate processing of the one or more contextual records to determine at least one profile for the at least one feature anchor.

According to another embodiment, a computer-readable storage medium carries one or more sequences of one or more instructions which, when executed by one or more processors, cause, at least in part, an apparatus to determining at least one feature based, at least in part, on one or more contextual parameters. The apparatus is also caused to process and/or facilitate a processing of one or more contextual records to determine whether the at least one feature is a feature anchor based, at least in part, on whether the at least feature is represented above at least one threshold level. The apparatus is also caused to process and/or facilitate a processing of the one or more contextual records to determine at least one profile for the at least one feature anchor.

According to another embodiment, an apparatus comprises means for determining at least one feature based, at least in part, on one or more contextual parameters. The apparatus also comprises means for processing and/or facilitating a processing of one or more contextual records to determine whether the at least one feature is a feature anchor based, at least in part, on whether the at least feature is represented above at least one threshold level. The apparatus also comprises means for processing and/or facilitating a processing of the one or more contextual records to determine at least one profile for the at least one feature anchor.

In addition, for various example embodiments of the invention, the following is applicable: a method comprising facilitating a processing of and/or processing (1) data and/or (2) information and/or (3) at least one signal, the (1) data and/or (2) information and/or (3) at least one signal based, at least in part, on (or derived at least in part from) any one or any combination of methods (or processes) disclosed in this application as relevant to any embodiment of the invention.

For various example embodiments of the invention, the following is also applicable: a method comprising facilitating access to at least one interface configured to allow access to at least one service, the at least one service configured to perform any one or any combination of network or service provider methods (or processes) disclosed in this application.

For various example embodiments of the invention, the following is also applicable: a method comprising facilitating creating and/or facilitating modifying (1) at least one device user interface element and/or (2) at least one device user interface functionality, the (1) at least one device user interface element and/or (2) at least one device user interface functionality based, at least in part, on data and/or information resulting from one or any combination of methods or processes disclosed in this application as relevant to any embodiment of the invention, and/or at least one signal resulting from one or any combination of methods (or processes) disclosed in this application as relevant to any embodiment of the invention.

For various example embodiments of the invention, the following is also applicable: a method comprising creating and/or modifying (1) at least one device user interface element and/or (2) at least one device user interface functionality, the (1) at least one device user interface element and/or (2) at least one device user interface functionality based at least in part on data and/or information resulting from one or any combination of methods (or processes) disclosed in this application as relevant to any embodiment of the invention, and/or at least one signal resulting from one or any combination of methods (or processes) disclosed in this application as relevant to any embodiment of the invention.

In various example embodiments, the methods (or processes) can be accomplished on the service provider side or on the mobile device side or in any shared way between service provider and mobile device with actions being performed on both sides.

For various example embodiments, the following is applicable: An apparatus comprising means for performing the method of any of originally filed claims 1-10, 21-30, and 46-48.

Still other aspects, features, and advantages of the invention are readily apparent from the following detailed description, simply by illustrating a number of particular embodiments and implementations, including the best mode contemplated for carrying out the invention. The invention is also capable of other and different embodiments, and its several details can be modified in various obvious respects, all without departing from the spirit and scope of the invention. Accordingly, the drawings and description are to be regarded as illustrative in nature, and not as restrictive.

### BRIEF DESCRIPTION OF THE DRAWINGS

The embodiments of the invention are illustrated by way of example, and not by way of limitation, in the figures of the accompanying drawings:

FIG. 1 is a diagram of a system capable of providing intelligent processing of contextual information, according to one embodiment;

FIG. 2 is a diagram of the components of a context platform, according to one embodiment;

FIG. 3 is a flowchart of a process for providing intelligent processing of contextual information, according to one embodiment;

FIG. 4 is a flowchart of a process for tagging one or more features to determine at least one feature profile, according to one embodiment;

FIG. 5 is a flowchart of a process for determining one or more predicted contexts based on an ordering, according to one embodiment;

FIG. 6 is a flowchart of a process for determining one or more delivery methods for one or more device functions, according to one embodiment;

FIG. 7 is a flowchart of a process for determining one or more relationships between one or more news events and contextual information and/or sensor data, according to one embodiment;

FIG. 8 is a flowchart of a process for determining one or more current events and/or one or more predicted future events based on determined relationships, according to one embodiment;

FIG. 9 is a flowchart of a process for determining one or more events, according to one embodiment;

FIG. 10 is a diagram of contextual records, according to one embodiment;

FIG. 11 is a diagram illustrating the tagging of one or more features of a contextual parameter based on a feature anchor, according to one embodiment;

FIG. 12 is a diagram of histograms for determining one or more related contextual parameters, according to one embodiment;

FIG. 13 is a diagram illustrating the formation of a feature profile based on related contextual parameters, according to one embodiment;

FIG. 14 is a diagram of a user profile, according to one embodiment;

FIGS. 15A and 15B are diagrams of user interfaces utilized in the processes of FIGS. 5 and 6, according to various embodiments;

FIGS. 16A and 16B are diagrams of user interfaces utilized in the processes of FIGS. 7-9, according to one embodiment;

FIG. 17 is a diagram of hardware that can be used to implement an embodiment of the invention;

FIG. 18 is a diagram of a chip set that can be used to implement an embodiment of the invention; and

FIG. 19 is a diagram of a mobile terminal (e.g., handset) that can be used to implement an embodiment of the invention.

### DESCRIPTION OF SOME EMBODIMENTS

Examples of a method, apparatus, and computer program for providing intelligent processing of contextual information are disclosed. In the following description, for the purposes of explanation, numerous specific details are set forth in order to provide a thorough understanding of the embodiments of the invention. It is apparent, however, to one skilled in the art that the embodiments of the invention may be practiced without these specific details or with an equivalent arrangement. In other instances, well-known structures and devices are shown in block diagram form in order to avoid unnecessarily obscuring the embodiments of the invention.

Although various embodiments are described with respect to a feature referring to a location as part of contextual information, it is contemplated that the approach described herein may be used with any type of contextual information.

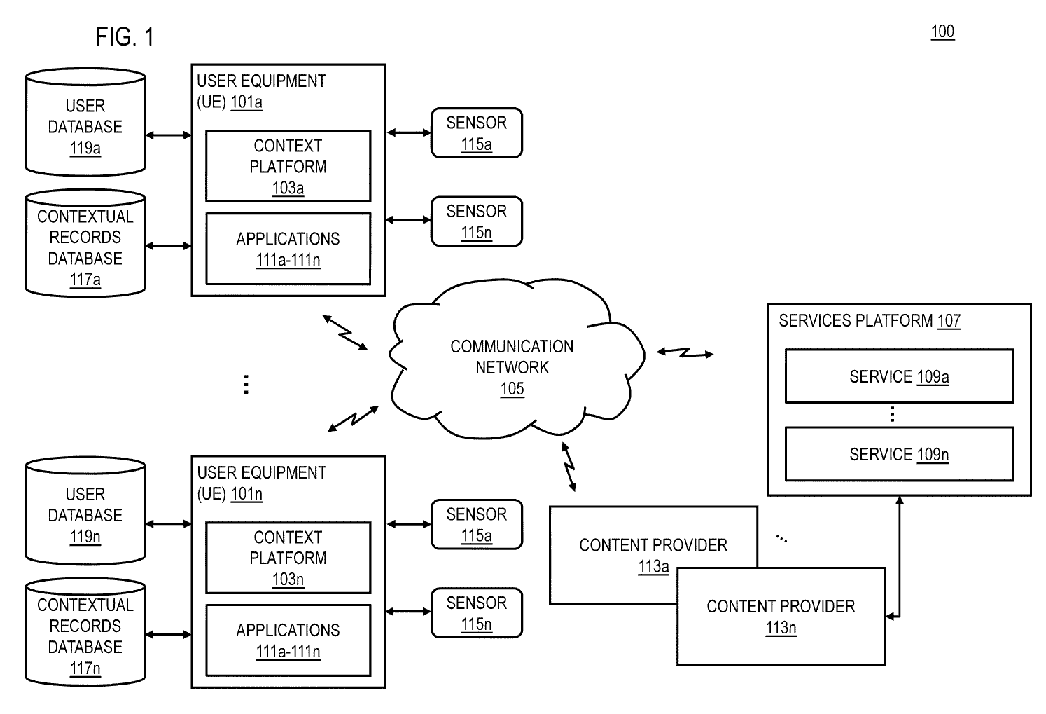

FIG. 1 is a diagram of a system capable of providing intelligent processing of contextual information, according to one embodiment. As discussed above, with the proliferation of sensors at mobile devices, mobile devices may be used to collect information about the environment of the mobile device, the environment of the user of the mobile device, preferences of the user, and behavior of the user. Service providers and device manufacturers understand the importance of using this contextual information to provide services and/or functions for the user at the mobile device. Specifically, depending on the contextual information, the mobile device may provide the user with information, automatically or upon request. It is possible that this information may be relevant to past, present and future events and may be inferred or determined based on the contextual information that is acquired locally at the mobile device. In some instances, the contextual information acquired locally may be combined with other information, such as information from a remote server and/or cloud architecture. The collection and use of the contextual information relies upon the contextual information being properly organized and continuously updated, the ability to process the data to determine context-dependent situations, and the ability to dynamically extract relevant information by forming and executing context-dependent queries.

Normally, this processing is performed in a server and/or cloud architecture based on certain requirements, such a processing power and/or resource constraints. However, uploading all of the contextual information to a server and/or cloud architecture is usually unacceptable because of, for example, privacy concerns. For example, the contextual information associated with a mobile device and/or a user of the mobile device can be personal in nature such that a user may want to control where the information is sent and/or who receives the information. One of the solutions to this problem is to maintain and process the privacy sensitive information locally at the mobile device and share only part of the aggregated contextual information that is required and/or relevant. Yet, this setup may create additional problems and/or concerns that may be associated with other problems related to the mobile devices collecting the contextual-information.

Any architecture that solves the above problems may have to take into consideration several problems. For example, there are problems associated with collecting and maintaining relevant contextual information from multiple sources that cause resource consumption restraints. Any architecture should also be able to extract importance contextual information in real time and combine the various, related features of the contextual information (e.g., feature fusion). Such architecture should also be able to organize and label (e.g., tag) properly stored and/or compressed information for further processing, and find and/or navigate the contextual information. Such architecture should also be able to form and dynamically update queries to databases to extract information relevant to the contextual information. The architecture should also be able to analyze the results and/or content of queries and trigger, as needed, contextually dependent events, such as, for example, contextual reminders, location-based services, etc. Any architecture should also be able to build and dynamically update user profiles that may be accessed, shared, and/or uploaded to facilitate different services, such as recommendation and/or prediction services.

Further, previous uses of contextual information associated with user behaviors focus on how the user currently or presently interacts with a mobile device in different types of contexts. Such previous uses do not consider the use of the contextual information to understand certain behavioral regularities of a user with respect to certain features of the contextual information. For instance, tracking locations of a user across different times of day, across different days of the week, etc., can yield predictive models of a user's geographic behavior. Based on certain supervised and/or un-supervised machine learning techniques, likelihoods may be assigned to certain locations in which a user will be located, given his current and past locations, or given his current trajectory. While it is possible to use contextual information to predict the behavior of the user, there has been no attempt to use such contextual information in a manner to apply such knowledge to provide information to a user in a contextually sensitive manner.

Further, with the growing number of sensors being incorporated in mobile devices, the number of sensors associated with service provider networks is growing rapidly. Focusing on the individual devices, the information generated by the sensors, such as location, sound and/or acceleration, is relatively straightforward to interpret. However, with the introduction of many sensors across the service provider networks, new collaborative ways of collecting sensor data, such as participatory sensing, are likely to results in the discovery of new signals that may have no meaning or whose correlation with events is unknown. However, there has been no consideration to develop methods and architectures that considerate such participatory sensing. Thus, the potential power of sensor networks and sophisticated new sensing technologies has not been fully exploited. Specifically, some of the data that is being recorded is not being interpreted in a way that can be understood by the users and is therefore being wasted. There is a need, therefore, to organize and classify such contextual information in a manner that opens the interpretation of the contextual information to take advantage of the amount of information that is acquired over the large service provider networks and multitude of mobile devices and/or sensory devices.

To address these problems, a system 100 of FIG. 1 introduces the capability to providing intelligent processing of contextual information. The system 100 introduces the ability to determine at least one feature based, at least in part, on one or more contextual parameters. The contextual parameters may be various types of features that constitute contextual information acquired by, for example, a mobile device, or any other sensor and/or architecture (e.g., server farm and/or cloud service) that are stored in contextual records. Based on the determination of a feature, the system 100 introduces the ability to process the feature to determine if the feature constitutes a feature anchor. A feature may constitute a feature anchor if the feature is represented above at least one threshold level. Upon determining the feature anchor, the system 100 provides for the ability to tag the contextual information that is associated with the feature anchor. Based on the tagging, the system 100 may generate one or more feature profiles that are defined by the feature anchors in addition to the other contextual parameters that are associated with the feature anchors. When features of different contextual parameters are determined as feature anchors, that the system 100 allows for the fusion of various feature anchors and the feature profiles associated with the feature anchors. Additionally, the system 100 allows for the generation of user profiles and/or models based on the combination of feature anchors and/or feature profiles that are associated with a single user. The user profiles may then be accessed by one or more applications, one or more services, one or more content providers, or a combination thereof to provide information, content, functionality, or a combination thereof to the user and/or the user's mobile device based on the feature anchors, the feature profiles and/or the user profiles. The user profiles may be stored in a user database 119a-119n (collectively referred to as user database 119), along with other contextual information, sensor data, and/or event information. As illustrated in FIG. 1, the user database 119 may be connected to the UE 101 or may be embodied within the UE 101 (e.g., a local storage device within the UE 101). In one embodiment, the user database 119 may be associated with a service 109 on the services platform 107 and/or with a content provider 113.

Specifically, a context platform introduces the capability to collect, store, dynamically process and tag contextual information associated with a user that forms a basis for intelligent processing at a device. The system 100 provides for the ability to dynamically generate bottom-up extracted feature anchors. The system 100 further allows for the generation of machine readable tags for the feature anchors that are dynamically updated based on the collected contextual information. The feature anchors and/or the tags for the feature anchors may then be used to form automatic queries and to extract context-dependent information from the contextual information. The feature anchors may also be used to trigger different applications within the devices, such as contextual reminders, dynamic profile configurations, power consumption optimization, etc. The feature anchors may also act as the basis for a dynamic user profile associated with intelligent monitoring and various predictors associated with the contextual information.

The feature anchors further allow for the recursive labeling or tagging of previously recorded contextual information to create feature profiles. The feature profiles include all of the contextual information associated with the selected feature anchors. Specifically, the contextual information may come from multiple sources that may reflect different modalities of the same context. The feature anchors, or a subset of the feature anchors, may be used to infer feature profiles from the features of the contextual information that are not directly observable, and then assign relevant tags to these events and/or features. In one embodiment, the feature anchors may be determined with a certain accuracy that may be translated to accuracies in the events and/or features. By way of example, using detected feature profiles from user activity associated with the contextual information, which may include activity associated with connections of the device (e.g., WiFi, Bluetooth®, etc.), the contextual records may be automatically labeled according to, for example, semantic locations, which allows the system 100 to make predictions using, for example, collaborative filtering and/or other methods. Based on the accuracy measurements and/or determinations used in determining the feature anchors, the system 100 allows for iterative and/or recursive methods for determining the feature anchors and/or profiles with improved accuracy, which may be used to improve the accuracy of the feature profiles.

The system 100 also allows for a combination of the profiles (e.g., feature profiles) to form dynamically updated user profiles that may be organized in a multi-dimensional matrix (tensor) format. By way of example, a user profile may be arranged in the form of a what/when/where matrix that facilitates the searching of information used by applications, such as applications that provide contextual reminders, various predictors/recommenders and feature-based services. By way of example, as discussed above, the gathering of the contextual information raises problems associated with power consumption. Specifically, the ability to collect the contextual information at finer and finer granularities, especially for battery-powered mobile devices, raises issues regarding how much information to collect versus how much battery life to maintain. Such predictions based on a user profile may be used to control sensors and adapt measurement strategies. Such control and/or adaptation may be used to, for example, activate/de-activate one or more sensors, set sensor sampling rates, etc.

The system 100 also allows for the generation of one or more profiles and/or models associated with a user that allow for the prediction of features, behaviors and/or preferences associated with the user and/or a device associated with the user. Associated with the predictions of the features, behaviors and/or preferences, the system 100 may also generate chronological reference points (CRPs) that reference a chronological point in time with respect to the prediction of the features, behaviors and/or preferences. The system 100 may then have one or more functions triggered based on the CRPs for a particular feature. Based on a user's interactions with the triggered functions, the system 100 may analyze how the user responds to the functions. The analysis may provide one or more cues that indicate how a user will respond to the functions. Based on the cues, the system 100 may provide the one or more functions according to the optimal conditions of the user such that the functionality is provided to the user and/or the user's device under the best conditions for the user to act on or respond to the functionality.

The system 100 also allows for the correlation of feature-tagged sensor data and contextual information with one or more events to create models that relate contextual information and/or sensor data with the events. The correlation may then be used to determine patterns in the contextual information and/or sensor data that otherwise would be undetected and/or not semantically classified. The correlation may occur after successive iterations between the contextual information and/or the sensor data with the events. The system 100 may then generate one or more models based on the correlation that relate the previously determined and processed contextual information and/or sensor data with current and/or future events to classify the current and/or future events.

As shown in FIG. 1, the system 100 comprises user equipment (UE) 101a-101n (collectively referred to as UE 101) including context platforms 103a-103n (collectively referred to as a context platform 103) having connectivity to a communication network 105. As illustrated in FIG. 1, the context platform 103 may be located at the UE 101. In such an embodiment, one or more hardware and/or software modules and/or elements may perform the functions described as being performed by the context platform 103, at the UE 101. In such an embodiment, for instance, contextual information that is processed by the context platform 103 may reside and remain at the UE 101 rather than needing to be transmitted to another element within the system 100. Thus, where the UE 101 is a mobile device, such an embodiment may reduce the resource consumption of, for example, the battery by not having to transmit the collected contextual information over the communication network 105 to a remote context platform 103. Such an embodiment may also reduce privacy issues by maintaining private information at the UE 101 rather than transmitting the private information over the communication network 105. However, in one embodiment, the context platform 103 may also be a standalone element of the system 100 that may communicate with the UE 101 over the communication network 105. Further, in one embodiment, the context platform 103 may be embodied in one or more of the services 109 on the services platform 107, discussed below.

By way of example, the communication network 105 of the system 100 includes one or more networks such as a data network, a wireless network, a telephony network, or any combination thereof. It is contemplated that the data network may be any local area network (LAN), metropolitan area network (MAN), wide area network (WAN), a public data network (e.g., the Internet), short range wireless network, or any other suitable packet-switched network, such as a commercially owned, proprietary packet-switched network, e.g., a proprietary cable or fiber-optic network, and the like, or any combination thereof. In addition, the wireless network may be, for example, a cellular network and may employ various technologies including enhanced data rates for global evolution (EDGE), general packet radio service (GPRS), global system for mobile communications (GSM), Internet protocol multimedia subsystem (IMS), universal mobile telecommunications system (UMTS), etc., as well as any other suitable wireless medium, e.g., worldwide interoperability for microwave access (WiMAX), Long Term Evolution (LTE) networks, code division multiple access (CDMA), wideband code division multiple access (WCDMA), wireless fidelity (WiFi), wireless LAN (WLAN), Bluetooth®, near field communication (NFC), Internet Protocol (IP) data casting, digital radio/television broadcasting, satellite, mobile ad-hoc network (MANET), and the like, or any combination thereof.

The UE 101 is any type of mobile terminal, fixed terminal, or portable terminal including a mobile handset, station, unit, device, mobile communication device, multimedia computer, multimedia tablet, Internet node, communicator, desktop computer, laptop computer, notebook computer, netbook computer, tablet computer, personal communication system (PCS) device, personal navigation device, personal digital assistants (PDAs), audio/video player, digital camera/camcorder, positioning device, television receiver, radio broadcast receiver, electronic book device, game device, or any combination thereof, including the accessories and peripherals of these devices, or any combination thereof. It is also contemplated that the UE 101 can support any type of interface to the user (such as “wearable” circuitry, etc.).

The UE 101 may include and/or be associated with one or more sensors 115a-115n (collectively referred to as sensors 115). The sensors 115 may be any type of sensor that may acquire any type of information associated with, for example, the UE 101, the user of the UE 101, the behavior and/or preferences of the user, the environment of the UE 101 and/or the user of the UE 101. Exemplary embodiments of the sensors 115 may include accelerometers, microphones, light sensors, WiFi adapters, Bluetooth® sensors, imaging sensors (e.g., camera), barometers, moisture sensors, etc. The data collected and/or acquired by the sensors constitutes, at least in part, the contextual information. The data collected and/or acquired by the sensors also may constitute, at least in part, a sensor data, as discussed below.

The UE 101 may include one or more applications 111a-111n (collectively referred to as applications 111). The applications 111 may be associated with any type of application that may run on the UE 101, such as one or more navigational applications, one or more calendar applications, one or more social networking applications, one or more personal and/or financial management applications, etc. In one embodiment, one or more of the applications 111 may include the functionality to provide one or more reminders that the user may generate. In one embodiment, the context platform 103 may interface with one or more of the applications 111 to generate the one or more reminders. Further, in one embodiment, one or more of the applications 111 at the UE 101 may be associated with and/or perform the functions of the context platform 103. Specifically, the one or more applications 111 may perform all of the functions of the context platform 103 such that the functions of the context platform 103 are embodied in one or more of the applications 111. In one embodiment, one or more applications 111 may collect the contextual information acquired by the applications 111 and/or the sensors 115 and forward the contextual information to the context platform 103 for subsequent processing and analysis of the information, when the context platform 103 is not embodied within the UE 101.

The system 100 further includes a services platform 107 that includes one or more services 109a-109n (collectively referred to as services 109). The services can be any type of services that may be provided to any of the features of the system 100. By way of example, the services 109 may include one or more recommendation services, one or more contextual information gathering services, one or more navigational services, one or more calendar and/or personal organization services, one or more social networking services, one or more event delivery services (e.g., a news event delivery service), one or more sensory services, etc. With respect to the event delivery services, these services may deliver one or more events to the UE 101 for users of the UE 101 to view and for correlation to the contextual information and/or sensor data acquired by the UE 101. With respect to the social networking services, these services may be accessed by the UE 101 for a user to transmit one or more social networking messages. As discussed above, in one embodiment, one or more of the functions performed by the context platform 103 may be performed by one or more services 109. For instance, the context platform 103 may be embodied as a service 109 within the services platform 107.

The system 100 also includes one or more content providers 113a-113n (collectively referred to as content providers 113) that provide content to one or more of the features within the system 100. The content may be any type of content, such as contextual information regarding one or more elements of the system 100 (e.g., UE 101), social networking content, one or more events, such as one or more news events that may be associated with the elements of the system 100. In one embodiment, the context may be related to one or more events, such as one or more news events.

As discussed above, the system 100 also includes a context platform 103. The context platform 103 may collect the contextual information regarding the device's and/or user's environment, the user's preferences, and the user's behavior, etc. from the applications 111, sensors 115, one or more services 109, and/or content providers 113, and perform feature extraction. In one embodiment, the collected information may be associated with the time interval when the information was collected such that the contextual information and/or sensor data include, for example, time stamps. For example, every event/measurement has a time stamp associated with the time the event/measurement was recorded. Once a feature and/or contextual parameter is above a set threshold, the feature and/or contextual parameter may be considered a feature anchor. The threshold may be conditioned by time and/or other feature windows (e.g., such as within a certain location, associated with one or more other devices, etc.). By way of example, for a given area of a location and a given time period, a location anchor may be found where the location remained the same within the given time period and the given area of location.

A reliability measurement may be associated with the feature anchor associated with the length of time of the interval compared to the length of time during the interval that the feature of the contextual parameter is represented above the threshold. In one instance, the relevant time interval associated with the feature anchor is tagged with a feature tag by, for example, adding a field to a contextual records database 117a-117n (collectively referred to as contextual records database 117) storing the contextual parameter. In one embodiment, the contextual records database 117 may be associated with the UE 101 (e.g., a local storage device within the UE 101). The feature tag may be in a general vector format and may include the reliability measurements that are stored and dynamically updated in fields within the database that may be accessed via an application programming interface by the applications 111. In one embodiment, depending on the event/measurement associated with the features, the features may be normalized as probability density functions to prevent overflow. In such a case, the normal value may be stored. In such an embodiment, the feature anchors may be ranked, for example, by their normal values, and merged for a compact presentation.

Upon a creation of a feature anchor, the context platform 103 searches the contextual information organized into contextual records that include the contextual parameters and tags (e.g., adds a feature tag) all of the time intervals where the selected feature is recorded. By way of example, where a certain location (e.g., one type of contextual parameter) is determined as a feature anchor, the context platform 103 searches the contextual records to determine the location contextual parameter that matches the location of the feature anchor. The contextual records that are tagged with the location anchor may also be associated with the reliability measurement associated with the location, such as the proportion of the amount of time associated with the location within a set location area versus the period of time. In one embodiment, the system 100 allows for a user associated with the device that is associated with the feature anchor to label the feature anchor. The labeling of the feature anchor may be used for communications with the user regarding the feature anchor and information derived and/or generated based on the feature anchor.

Subsequently, all of the available features associated with the contextual parameters within the contextual records that are marked with the feature tag are processed (e.g., in the form of vectors and/or histograms) to determine at least one feature profile that is dynamically updated from a continuous sensing of contextual information. By way of example, for the given location, other measurements, such as proximities to other devices associated with connections (e.g., Bluetooth®, WiFi, etc.), social activity regarding, for example, call logs, calendar events, etc., other environment activity regarding, for example, accelerations, audio, light, application usage, media information, may all be linked to the location that is associated with the feature anchor. Based on this information, the system 100 may form histograms for each of the contextual parameters associated with the contextual parameter indicated as a feature anchor. For all of the other features that were tagged with the feature tag (e.g., the other contextual parameters associated with the same location at different time periods), the system 100 may similarly process the additional information to form histograms (e.g., density functions). Based on the processing, the system 100 may extract other contextual parameters that are the most relevant for the given feature associated with the feature anchor. By way of example, for a given location determined to be a feature anchor, the system 100 may determine that other devices may be associated with the location (e.g., in the proximity of the user's device UE 101) when at the location, or that the user primarily calls certain phone numbers when at the location.

In one embodiment, the above information regarding the contextual parameters may be grouped into various density functions according to, for example, time constraints. For example, the information may be divided into work day versus weekend and/or holiday. The time tags associated with the contextual parameters may be used to divide the information into, for example, mornings (e.g., 8-10), work (e.g., 10-18), free time (e.g., 18-23), and free time (e.g., 23-8). However, the categorization of the information may be conducted according to any type of schedule for any type of granularity limited only by the granularity of the collection of the information (e.g., the granularity of the time periods). Based on this information, feature profiles may be created based on the feature anchor and the related contextual parameters according to the groupings. By way of example, according to the feature anchor associated with a specific location, a profile associated with the location may be created such that, for example, during working days the user associated with the device is most likely to call number X and be in proximity of WiFi SSID Grandma's Home while using a calendar application for reminders. Based on the probability associated with the one or more location anchors that are used to generate the feature profile, the feature profile may similarly have a probability.

In one embodiment, more than one feature of the various different contextual parameters may be determined as feature anchors such that there is overlapping information. Thus, one or more contextual parameters may be tagged according to two or more feature anchors. The resulting overlapping may be used to improve the accuracy and/or reliability. For example, the overlapping feature anchors are associated with overlapping probabilities that may be improved upon based on an iterative process. This may be considered feature fusion where two or more features are fused together to generate a linking between feature anchors and feature profiles that may be associated with different and/or various modalities of the contextual information.

Feature profiles may subsequently be used to label time intervals with missing information, infer hidden features and/or improve accuracy of tagging/profiling. By way of example, one or more feature profiles may include one or more features associated with one or more contextual parameters that are missing from one or more time intervals. However, the one or more time intervals may have features in common with other features of contextual parameters within one or more other feature profiles. Thus, one or more other feature profiles may be used to fill in the missing features for the time intervals. The feature profiles may subsequently be merged to form one or more user profiles. The user profiles are composed of one or more feature profiles and may be in the form of, for example, a matrix. The user profiles may subsequently be used to control functionality, make recommendations, and/or predictions associated with a user. In one embodiment, the user profiles may be uploaded to a server farm and/or cloud architecture.

In one embodiment, feature profiles are analyzed to find clusters at different resolution levels corresponding to behavior patterns and/or actions associated with tagged events/times. Additionally, under certain conditions, the clustered (merged) features are added as extra fields to the predefined initial queries (associated with unsupervised or semi-supervised learning) to trigger database requests related to (merged) feature anchors. Additionally, extra fields in modified queries may perform information filtering relevant to the detected events and activate applications and/or services, such as recommendation engines.

In one embodiment, one or more of the applications 111 may be associated with collecting raw data. Such one or more applications may be considered as a software agent of the context platform 103. The software agent may collect the raw data from the one or more sensors 115 and/or services 109, etc. regarding the UE 101's and/or user's environment, user's preferences, and the user's behavior. The raw data similarly may be acquired from one or more other sensors 115, such as a camera associated with the UE 101 capturing one or more images and/or videos. The raw data may be continuously recorded at any set interval and stored in a database (e.g., SQL database, such as the contextual records database 117a-117n associated with the UE 101).

As the context platform 103 is continuously determining new contextual information, the context platform 103 is iteratively forming the feature anchors and/or generating new feature anchors. In one embodiment, the content platform includes a forgetting function for one or more user profiles, feature profiles, feature anchors, and/or features. By way of example, the reliability numbers that are associated with a feature anchor may be incremented down based on a function of time since the feature was determined a feature anchor if there are no updates to the feature anchor. Further, other feature anchors may be determined that have higher reliability measures that may be selected over feature anchors with lower reliability measures. Although the measures are not necessarily incremented down in one embodiment, the contextual information associating with one feature anchor over another will automatically increase the reliability of the more used feature anchor over the other. Further, features within the contextual records may be erased over time if the features are not recently tagged according to a feature anchor.

In one embodiment, the context platform 103 further allows the chronological progression of contextual events to be tracked for a user based on the contextual information collected. By way of example, in the case of geographic behavior, the locations of the user may be tracked, as well as the routes used to transition from one location to a subsequent location. The context platform 103 may then learn the routes and locations used by the user. The context platform 103 further provides, based on such information, a predictive model for the geographic behavior (e.g., feature behavior). Based on the model, the system 100 may derive an estimate, given a present location of the user, as to which location the user is most likely to transition to next. For instance, if the user is in a location Office, the user's next location may be Home on all weekdays except Tuesdays when the user typically goes to the location Gym after leaving Office, rather than Home. The context platform 103 may use supervised and/or un-supervised machine learning techniques, or Bayesian reasoning, to predict locations (or any type of feature) likely to be encountered by a user within a set timeframe given the user's past features and the user's current features.

The context platform 103 may further utilize the chronological progression of features by operationalizing the features as they unfold with respect to a time dimension. Subsequently, chronological reference points (CRPs) may be identified with respect to the chronological progression. For instance, with respect to location, CRPs may be (a) when in a previous location, (b) when checking out from a previous location, (c) when in a transit mode to a target location, (d) when checking in to the target location, (e) when in the target location, and (f) when checking out from the target location. For each of the CRP type, various contextual information can be maintained to facilitate the accurate recognition of the CRP type. Additionally, although related to location, the CRPs may be associated with any type of feature.

The CRPs may be used for the execution of various functions at the mobile device. In one embodiment, the CRPs may be used in the execution of various contextual reminders associated with one or more applications. Specifically, a user may create a reminder that is associated with a CRP and that is triggered based on the CRP chosen. For instance, associated with location CRPs, if a user selects a target location for the reminder, the user can select the triggering logic for the reminder by choosing one of the CRPs. If the user chooses CRP (a) (e.g., when in a previous location), a reminder that she has selected or created may be delivered when in the previous location based on a prediction and/or a determination by a user profile and/or model. Further, if the user chooses CRP (b) (e.g., when checking out from a previous location), a reminder that she has selected or created may be delivered when checking out from a previous location.

In one embodiment, the system 100 collects information regarding user interactions with the triggered functionality, such as the manner in which the user accesses and/or interacts with the triggered functionality. Based on the tracking, the system 100 may derive individualized models for contextually sensitive delivery of prompts. Specifically, for each CRP, the system 100 may determine the context in which the user accepts and/or dismisses the triggered functionality, as well as, for example, the time it takes for the user to respond to the triggered functionality. For example, at the time of delivering a reminder, a microphone associated with the mobile device can sample the audio of the environment of the user, accelerometer readings can be captured, as well as any devices detected in the vicinity of the mobile device. Based on this information, the context platform 103 may identify rapid versus slow responses, as well as contextual cues that may indicate a reason for the rapid or slow response to the reminders, that the context platform 103 may cues to predict fast or slow responses to the reminders in the future. Based on the response information, the context platform 103 may generate a model and provide the model to one or more applications 111 and/or services 109 that may use the model to deliver and/or provide functionality to the user based on the user's ability to respond to the functionality. The models may recognize the CRPs for a given feature, along with a list of cues predictive of fast and/or slow responses with respect to the features.

In one embodiment, the raw contextual data may be processed to convert the data into a format that is amendable to statistical analysis. For instance, activity recognition algorithms may be applied to an audio signal to identify the activity the user is engaged in at the time of the sensor reading (e.g., typing, quiet, in a meeting, etc.). Subsequently, multiple regression techniques may be applied to predict response times to the triggered functionality. Predictors or cues for both short as well as long reaction times are identified for the user. In one embodiment, the statistical analysis occurs separately across reference locations and CRP classes. For example, a location of Home is provided a separate analysis across the CRP classes. In one embodiment, the cues that are deemed to act as predictors of fast responses are used to trigger the functionality. The cues that are associated with slow responses are used in a negative fashion by avoiding the functionality during the presence of such a cue.

In one embodiment, where the CRPs and cues may be related to locations, the framework of the system 100 may be opened up to the applications 111 and services 109 with respect to the learned locations of the user compared to points of interests. Commercial opportunities in the proximity of each reference location may be identified and commercial functionality may be provided by one or more applications 111, services 109, and/or content providers 113 by determining when and where the user will be and the cues that indicate when to provide the functionality. By way of example, the context platform 103 is able to predict the user's future location, pinpoint commercial opportunities in the proximity of the location, and deliver information regarding the commercial opportunities to the user related to the locations during a contextually sensitive and/or optimal time based on the locations and the various CRPs. By way of example, a user may receive a coupon when the user arrives at a location that is associated with a nearby commercial entity. Further, the user may be notified of a sale at a location when the context platform 103 determines that the user is on his way to the location. Any other feature may be analyzed by the context platform 103, such as any activity the user is executing (e.g., hiking, biking, riding a horse, driving a car, etc.) and there may CRPs generated based on the activity. By way of example, the user may complete a long hike and be notified of one or more commercial opportunities related to commercial entities associated with hiking.

The context platform 103 further provides the ability to correlate feature-tagged sensor data for specific sensor events with feature-based semantic descriptions from feature-tagged social networking or other semantic news feeds to create models that link sensor data with semantic descriptions of events. The semantic descriptions may then be used to semantically tag events. The context platform 103 also provides the ability to provide iterative classification of previously unknown information according to various contextual features to produce an analytical model that may be shared among users and/or devices associated with the service provider networks. The models may be further optimized through successive iterations by subsequent users and/or devices. Thus, the context platform 103 provides the ability to acquire contextual information associated with a mobile device, detect events associated with the mobile device (e.g., such as one more news events, one or more personal events, or a combination thereof), associate the contextual information with the events, iterate over multiple events of the same type and/or semantic classification to generate one or more models, and share the models among one or more other devices, which may then contribute under a peer-to-peer model to maintain and evolve the one or more models.

The events may be user nominated and/or generated, or acquired from incoming and/or outgoing communications with the UE 101, such as SMS messages, MMS messages, email, social networking messages, global broadcast news feeds, etc. The events are associated with the UE 101 and the contextual information such that the contextual information, in part, defines the events. If the event more than one news event is associated with the UE 101 for particular contextual information, such as for a particular time, one or more of the news events may be compared and/or associated with the contextual information.

In one embodiment, the context platform 103 may store contextual information and/or sensor data for a period of time (e.g., n samples of contextual information) until a news event occurs. The news event may either be user nominated/generated or selected from incoming communications. The news event may be selected based on the event being associated with a feature of the contextual information, such as the location. In one embodiment, the user and/or the context platform 103 may determine to retain the data and correlate the date with the acquired events. Accordingly, the contextual information and/or sensor data may be associated with the semantic information of the event and define the event. Subsequently, other contextual information and/or sensor data may be acquired. The subsequently acquired contextual information and/or sensor data may be compared to the previously acquired information to determine if the subsequently acquired contextual information correlates to one or more previously determined events using one or more models. If there is no contextual information and/or sensor data that correlates to an acquired event, the event may be stored for later determinations of correlated contextual information and/or sensor data. These events may be marked as being untagged such that they may be compared with out events and/or contextual information at a later date.

By way of example, the UE 101, communicate with each other and other components of the communication network 105 using well known, new or still developing protocols. In this context, a protocol includes a set of rules defining how the network nodes within the communication network 105 interact with each other based on information sent over the communication links. The protocols are effective at different layers of operation within each node, from generating and receiving physical signals of various types, to selecting a link for transferring those signals, to the format of information indicated by those signals, to identifying which software application executing on a computer system sends or receives the information. The conceptually different layers of protocols for exchanging information over a network are described in the Open Systems Interconnection (OSI) Reference Model.

Communications between the network nodes are typically effected by exchanging discrete packets of data. Each packet typically comprises (1) header information associated with a particular protocol, and (2) payload information that follows the header information and contains information that may be processed independently of that particular protocol. In some protocols, the packet includes (3) trailer information following the payload and indicating the end of the payload information. The header includes information such as the source of the packet, its destination, the length of the payload, and other properties used by the protocol. Often, the data in the payload for the particular protocol includes a header and payload for a different protocol associated with a different, higher layer of the OSI Reference Model. The header for a particular protocol typically indicates a type for the next protocol contained in its payload. The higher layer protocol is said to be encapsulated in the lower layer protocol. The headers included in a packet traversing multiple heterogeneous networks, such as the Internet, typically include a physical (layer 1) header, a data-link (layer 2) header, an internetwork (layer 3) header and a transport (layer 4) header, and various application (layer 5, layer 6 and layer 7) headers as defined by the OSI Reference Model.

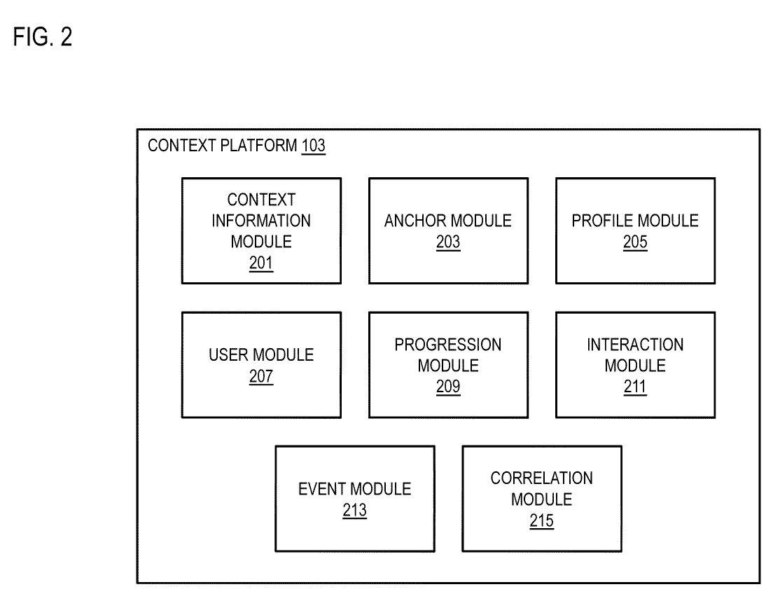

FIG. 2 is a diagram of the components of a context platform 103, according to one embodiment. By way of example, the context platform 103 includes one or more components for providing intelligent processing of contextual information. It is contemplated that the functions of these components may be combined in one or more components or performed by other components of equivalent functionality. As discussed above, the context platform 103, the contextual records database 117 and/or the user database 119 may be embodied at the UE 101, such that one or more hardware and/or software modules and/or elements of the UE 101 perform the functions associated with the context platform 103, the contextual records database 117 and/or the user database 119. For instance, the functions of the context platform 103 may be performed by one or more applications 111 and the information included within the contextual records database 117 and the user database 119 may be stored at a local storage device within the UE 101. In one embodiment, the functions associated with the context platform 103 may be embodied in one or more services 109 on the services platform 107, or be a standalone element of the system 100, and the UE 101 may communicate with the context platform 103 over the communication network 105. Thus, the functions of the context platform 103 may be performed at the UE 101 or at one or more elements of the system 100.

In this embodiment, the context platform 103 includes a context information module 201, an anchor module 203, a profile module 205, a user module 207, a progression module 209, an interaction module 211, an event module 213, and a correlation module 215.

The context information module 201 collects the contextual information that is acquired by the UE 101 through the sensors 115, the applications 111, the services 109 and/or the content providers. The context information module 201 may organize and store the contextual information within the contextual records database 117. The context information module 201 may also tag the contextual information with time stamps based on when the contextual information is acquired.

The anchor module 203 determines one or more feature anchors based on features of one or more contextual parameters within the one or more contextual records. In one embodiment, a feature will constitute a feature anchor when the feature satisfies one or more thresholds. By way of example, for a location, if a user and/or UE 101 is at a particular location for longer than a set duration (e.g., threshold), the particular location may be considered a feature anchor. The determination of the location may be for a given area and/or for a given time period. For example, the determination of the given location may be for a given time period Δt and may be for a given area ΔL. Thus, if the location is determined to be a same location for the give time period Δt and for the given area ΔL, the location may be considered a feature anchor (e.g., a location anchor). The feature may be a feature anchor because satisfying the threshold indicates that the feature is, for example, a common feature to the user.

The anchor module 203, upon determining a feature anchor, may tag the record of the feature in the contextual records database 117 as constituting a feature anchor. Subsequently, the anchor module 203 may tag the features associated with the other contextual parameters for the given time period Δt as being associated with a feature anchor. Further, the anchor module 203 may search over all of the contextual records within the contextual records database 117 to determine the features as the same contextual parameter of the feature anchor that match the feature anchor. For example, multiple time stamps may be associated with a specific location that is determined to be a feature anchor based on at least one of the time stamps. Accordingly, the anchor module 203 may tag the features as being associated with the feature anchor based on the same contextual location. Further, the anchor module 23 may determine that all of the related contextual parameters associated with the features that were tagged as being related to the feature anchor as also relating to the feature anchor. Thus, by way of example, all of the contextual records that are associated with a feature of a contextual parameter that is determined to be a feature anchor may be determined to be related features of related contextual parameters of the feature anchor. Thus, the anchor module 203 may determine a subset of the features of various contextual parameters within the contextual records database 117 that are associated with a feature anchor. In one embodiment, the anchor module 203 performs the above analysis for all of the features within the contextual records database 117 such that there may be multiple feature anchors.

The profile module 205 processes the information determined by the anchor module 203 to determine the contextual parameters that are related to the determined feature anchors, and the features of the context parameters. The profile module 205 may form histograms and/or density functions associated with the related contextual parameters to determine the one or more most related contextual parameters to the feature anchors. Based on the one or more most related contextual parameters, the profile module 205 may determine one or more feature profiles that include the feature anchor associated with the most related contextual parameters and/or all of the related contextual parameters. Where one or more feature anchors include overlapping related contextual parameters and/or most related contextual parameters, the profile module 205 may determine one or more related and/or fused feature profiles. Similarly, the user module 207 determines the one or more user profiles and/or models for a user based on the feature anchors and/or the feature profiles. The user profiles may include all of the feature profiles that are determined for a user based on the contextual information and/or sensor data that is collected for the users.

The progression module 209 may analyze the progression of the contextual information with respect to a user to determine patterns in the contextual information that indicate what features and/or contexts occur before subsequent features and/or context. By way of example, the progression module 209 may track the chronological progression of contextual events for a user based on geographic behavior, the locations visited by a user, as well as the routes taken by the user to transition to the different locations. The progression module 209 may then create a predictive model based on the chronological progression to determine, based on the current contextual information associated with a user, predicted features and/or future contextual information associated with the user. With respect to location, for example, the progression module 209 may track a user's location to determine the locations that a user visits in chronological order, in addition to the routes the user uses to go from location to location. The locations that regularly occur may be determined as location anchors based on the disclosure above. Other contextual parameters associated with the location anchors may reveal the patterns in the contextual information that indicate that a user is traveling to a subsequent location along the route. Accordingly, the progression module 209 may determine one or more user profiles and/or models that reveal locations that a user is traveling towards and the routes the user is taking. However, the progression module 209 may determine similar tracking and “transition” information regarding any feature within the contextual records. For example, the progression module 209 may determine the progression of websites the user visits while browsing the Internet, the progression of activities the user is associated with while getting ready for work in the morning, the progression of television shows the user watches on weeknights, etc. Thus, the same techniques associated with the feature of location may be applied to any contextual feature.

The progression module 209 may further determine chronological references points (CRPs) based on an operationalizing of the behavior of the user as the behavior unfolds against time. The CRPs may indicate the various points between features, such as the points between two locations. As discussed above, for the contextual parameter of location, the CRPs may be in a previous location, checking out from a previous location, in a transmit mode to a target location, checking into the target location, in the target location, and checking out from the target location, etc. Similarly, CRPs may be defined for any contextual parameter, such as during a previous call, ending a previous call, dialing a target number, during a current call, etc. for functionality associated with making phone calls with using a UE 101a. The progression module 209 allows for the linking of functionality with the CRPs such that the CRPs trigger functionality. By way of example, the CRPs may be used with a contextual reminder application 111a that allows a user to set reminders that are triggered based on a CRP chosen. If a user selects a target location for a reminder, the user may then select the triggering logic by selecting one of the CRPs. For instance, if the user selects the CRP of when in a previous location, the reminder will be triggered when the user is in the previous location of the target location, for example, when the progression module 209 predicts that the user will subsequently be in the target location after the previous location. If the user selects the CRP of checking out of the previous location, the reminder will be triggered when the user is checking out from the previous location before heading to the target location. Based on the various CRPs selected, at future points in time, the user will be reminded accordingly. As discussed, the reminders are just one example of functionality that may be triggered based on the chronological progression and models determined from the progression. Other functionality may be triggered, such as changing modes of the UE 101, placing one or more calls using the UE 101, sending one or more messages using the UE 101, etc.

The interaction module 211 tracks the interaction between the user and the functionality that may be configured based on the CRPs. The interaction module 211 provides the ability to derive user profiles and/or models for contextually sensitive delivery or execution of functionality. Specifically, for each CRP associated with each type of contextual parameter, the interaction module 211 determines one or more cues and/or interactions with the triggered functionality. By way of example, where the functionality is a reminder, the interaction module 211 tracks the user's interactions with the reminder to determine if the user dismissed the reminder and/or accepted the reminder when the reminder is first triggered. The interaction module 211 also determines the time the user takes to respond to the reminder (e.g., fast response to accept/dismiss and/or a slow response to accept/dismiss). In determining the interactions between the user and the functionality, the interaction module 211 analyzes contextual information associated with the triggering and/or response to the functionality to determine one or more cues associated with the interactions. The interaction module 211 processes the contextual information to determine what cues are associated with a fast/slow response as well as accept/dismiss. Based on the cues, the interaction module 211 may determine when and how to trigger the functionality that best suits the current context of the user.

The event module 213 collects information about one or more events. The event module 213 may collect information about the one or more events through one or more services 109, one or more content providers 113, and/or one or more applications 111 running on the UE 101. By way of example, one or more applications 111 running on the UE 101 may access one or more news content providers, such as one or more global news event content providers. One or more applications 111 may also access one or more services 109, such as one or more news event services providers. Additionally, one or more applications 111 may access one or more social networking services providers that may have information regarding one or more events. The events may be any type of event, such as a global, regional or local news event. The event may be personal to one or more users, such as a medical condition (e.g., heart attack, epileptic fit, etc.) that is experienced by a single person. The events may also be inferred from one or more communications, such as a text message that describes an event or a sensor 115 acquiring information specific to a certain type of event (e.g., barometric pressure related to weather patterns). In one embodiment, the events may be self-defined and/or nominated by the user of the UE 101.

The correlation module 215 correlates the contextual information and/or sensor information to one or more of the acquired events to create one or more event models and/or profiles that link the contextual information and/or sensor data with the subjects of the events. The correlation module 215 also provides iterative classification of unknown contextual information according to one or more features such that patterns may evolve that link events to the one or more features.

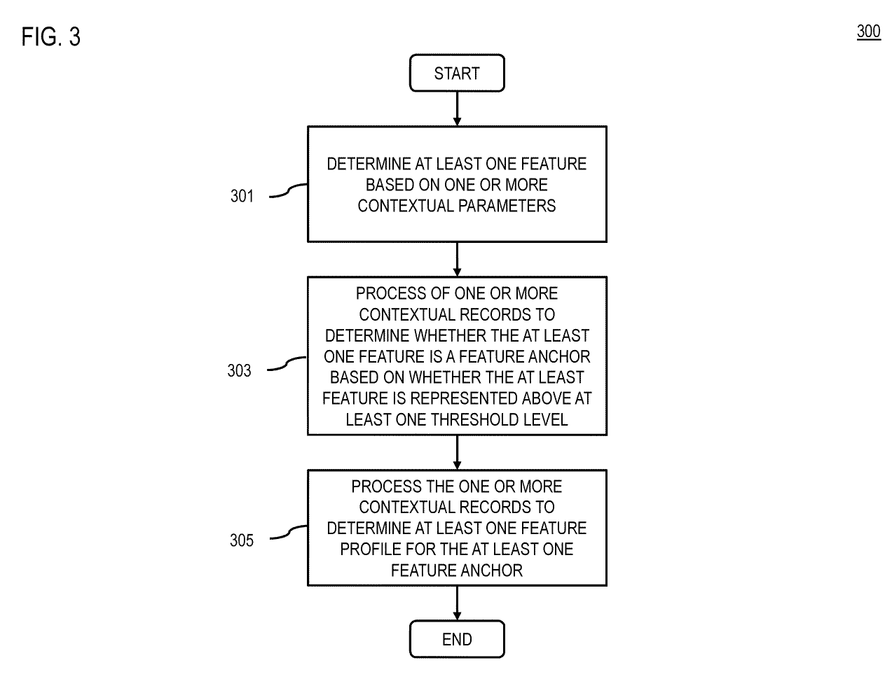

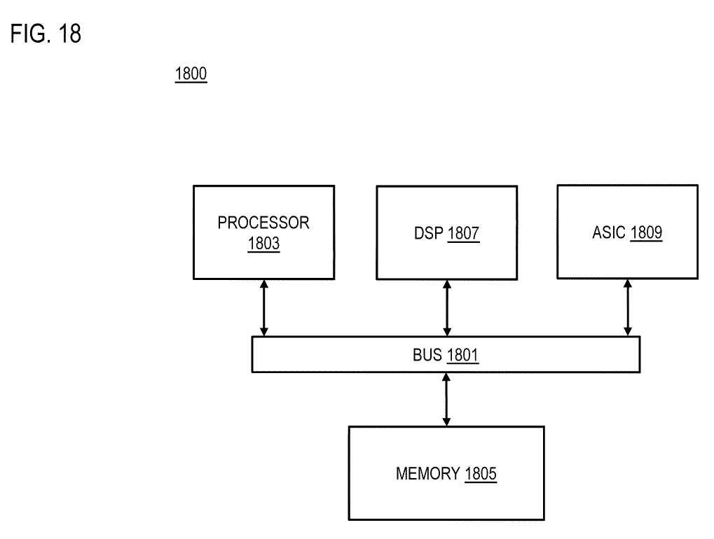

FIG. 3 is a flowchart of a process for providing intelligent processing of contextual information, according to one embodiment. In one embodiment, the context platform 103 performs the process 300 and is implemented in, for instance, a chip set including a processor and a memory as shown in FIG. 18. In step 301, the context platform determines at least one feature based, at least in part, on one or more contextual parameters. The context platform 103 may select one or more, if not all, of the features of the contextual parameters to determine if the features are features anchors. In one embodiment, the context platform 103 processes only certain contextual parameters that may be feature anchors based, at least in part, on one or more set contextual parameters and/or one or more contextual parameters that are commonly feature anchors (e.g., locations, phone numbers, WiFi SSIDs, etc.).

In step 303, the context platform 103 processes one or more contextual records to determine whether the at least one feature is a feature anchor based, at least in part, on whether the at least feature is represented above at least one threshold level. The at least one threshold level may be any type of metric that may determine a significance of the at least one feature. For instance, the at least one threshold may be a duration, a frequency, a percentage, etc. associated with the value represented by the feature. Where the feature represents a location, the at least one threshold may be associated with a duration of the location such that if a location occurs for a given duration, the feature of the location is determined a feature anchor. Where the feature is a contact within a call log, the at least one threshold may be, for example, the number of calls made to the contact within a set period of time. The context platform 103 may perform the above processing for all of the features within the contextual records database 117.

In step 305, the context platform 103 processes the one or more contextual records to determine at least one feature profile for the at least one feature anchor. The at least one feature profile may be a profile of one or more features that are related to the feature anchor that may be thought of as, for example, a subset of features that are normally associated for a given feature anchor. Accordingly, the feature anchor may be used to form the subset of features that constitute a feature profile. The subset of features may then be used to form and/or modify queries to trigger database requests related to the feature anchors. The feature profile may be used by one or more predictors and/or recommenders. In one embodiment, as discussed below, the feature profiles may be combined to form a user profile.

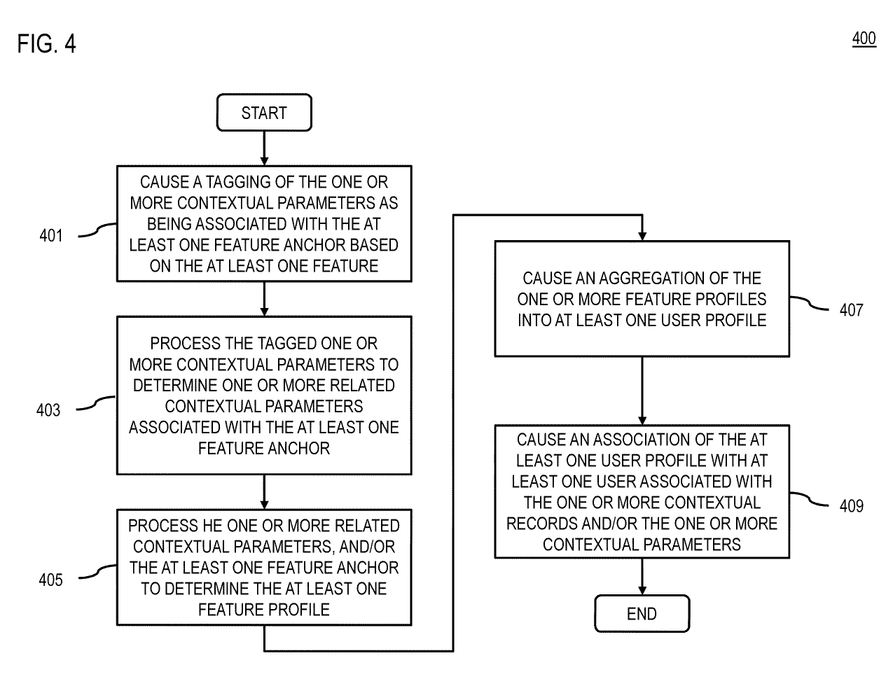

FIG. 4 is a flowchart of a process for tagging one or more features to determine at least one feature profile, according to one embodiment. In one embodiment, the context platform 103 performs the process 400 and is implemented in, for instance, a chip set including a processor and a memory as shown in FIG. 18. In step 401, the context platform 103 causes, at least in part, a tagging of the one or more contextual parameters as being associated with the at least one feature anchor based, at least in part, on the at least one feature. As discussed above, the feature may be a specific contextual parameter, such as location. The location determined as a feature anchor may have appeared throughout the contextual records for different time periods. At step 401, the context platform 103 determines all of the locations within the contextual record that match the location determined as the feature anchor. Thus, all locations associated with the location Home may be tagged as a feature anchor even though the location Home satisfied the at least one threshold only at one time period.

Next, in step 403, the context platform 103 processes the tagged one or more contextual parameters to determine one or more related contextual parameters associated with the at least one feature anchor. As discussed above, for each period of time, multiple contextual parameters may be collected as contextual information related to a user and/or a UE 101 associated with a user. The contextual parameters may include features that are therefore related to each other by, for example, the time period at which they were collected. Where one of the features is determined to be a feature anchor, the other features of the contextual parameters may be tagged as being associated with the feature anchor based, for example, on being collected at the same time. Thus, all of the features of the contextual parameters associated with one contextual parameter that is a feature anchor are tagged together.

In step 405, the context platform 103 processes the one or more related contextual parameters, the at least one feature anchor, or a combination thereof to determine the at least one feature profile. Based on the features that are associated with the feature anchor by having the same feature as the feature anchor within the same contextual parameters, as well as the features of the related contextual parameter, the context platform 103 may generate the feature profiles. The feature profiles may include the feature of the feature anchor in addition to the features of other contextual parameters that are related with the feature anchor. By way of example, certain activity, such as browsing the Internet, may occur such that the feature of browsing the web is determined a feature anchor. The feature of browsing the Internet may be associated with a location contextual parameter, such as the office. Thus, if the features of browsing the Internet and the location of the office occur regularly together, these two features may form a feature profile associated with the feature anchor of browsing the Internet. Thus, where the user is browsing the Internet, there is a probability that the user is at the office. The reverse may also be true. The location of the office may be determined as the feature and a feature profile may be build off of this anchor that determines that the user browses the Internet. In one embodiment, the feature profiles may also be associated with the probability or reliability scores associated with the feature anchor. Where the feature profiles are associated with one or more feature anchors, the combination of reliability measures for the feature anchors may be used to determine the reliability of the feature profiles.

In one embodiment, the process 400 proceeds to step 407 where the context platform 103 causes, at least in part, an aggregation of the one or more feature profiles into at least one user profile. The feature profiles may be combined according to the times that the feature profiles are associated with based on, for example, the time stamps and the group density functions and/or histograms associated with the features. The combination of the feature profiles generates a matrix that forms a user profile. The user profile may be thought of an as aggregation of the feature profiles, which are composed of the contextual parameters including the feature anchors and the feature, that form a what/where/when dimensional matrix.

In step 409, the context platform 103 may cause, at least in part, an association of the at least one user profile with at least one user associated with the one or more contextual records, the one or more contextual parameters, or a combination thereof. Thus, the user that is associated with the contextual information that is used to determine the feature anchors, the feature profile and the user profiles is associated with the generated user profiles. The user profiles for a user may then be uploaded to a personal and/or server cloud (e.g., OVI server) and used for recommendations, predictions, control of functionality at the UE 101, etc. The user profiles may be stored in the user database 119. In one embodiment, the creation of the feature anchors, the feature profiles and the user profiles is dynamic based on the continuous collection of contextual information. Accordingly, the steps associated with FIGS. 3 and 4, above, may be continuously updated based on new contextual information.

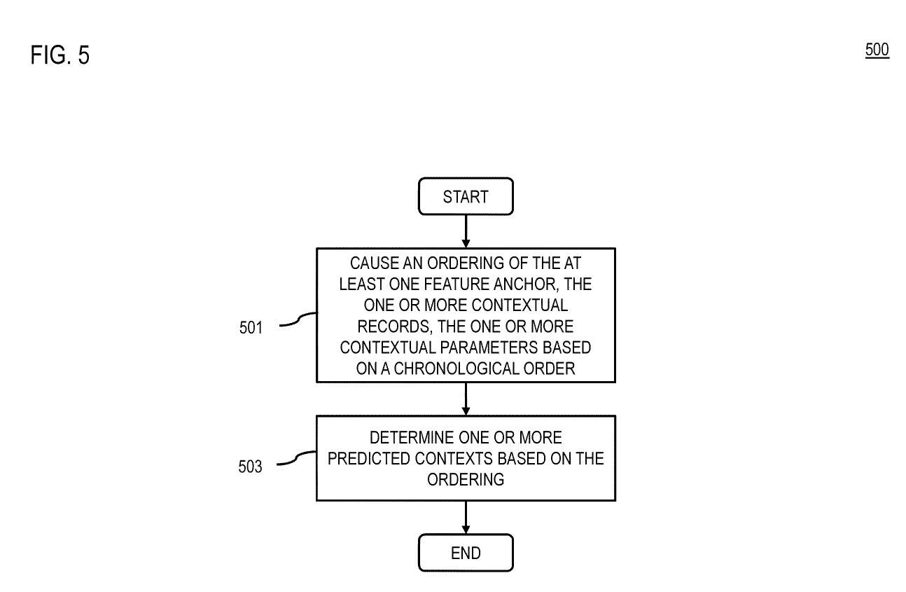

FIG. 5 is a flowchart of a process for determining one or more predicted contexts based on an ordering, according to one embodiment. In one embodiment, the context platform 103 performs the process 500 and is implemented in, for instance, a chip set including a processor and a memory as shown in FIG. 18. In step 501, the context platform 103 causes, at least in part, an ordering of the at least one feature anchor, the one or more contextual records, the one or more contextual parameters, or a combination thereof based, at least in part, on a chronological order. The ordering may be in a chronological order from when the events occur that are associated with the feature anchor, the one or more contextual records, the one or more contextual parameters. By way of example, if a user primarily calls user A after calling user B, the context platform 103 determines the chronological order of calls to be user B and then user A. If, after calling user A, the user primarily uses the Internet, the context platform 103 may also determine the chronological progression of calling user B, then calling user A, and the using the Internet.

Further, by way of example, if the user primarily is at a location Office and then proceeds to a location Home, the context platform 103 may determine such progression. The context platform 103 may also determine the progression with respect to multiple contextual parameters and/or time. For example, if the user primarily travels to location Gym after location Office on Tuesday, the context platform 103 may determine the distinction in the progression from Office to Home/Gym based on the day of the week. Further, the chronological ordering may be of any of the features in the contextual records, the contextual parameters, the feature anchors, or a combination thereof. Thus, the context platform 103 may determine the chronological progression regarding accelerometer information, audio information, lighting information, etc.

In one embodiment, the context platform 103 at step 501 further determines the transitions between features within the routing. By way of example, where the feature is location, the context platform 103 may consider the routes that are used to transition between two locations. The context platform 103 may store this information associated with the chronological ordering information. The behavior and the contextual information associated with a user are then learned and used to form a model that may then predict contextual information and future behavior of the user based on the previously determined contextual information. In determining this information, the context platform 103 may operationalize the behavior as it unfolds and determine various chronological reference points (CRPs). The CRPs may relate to the various features and the transitions between the features. As discussed above with respect to location, the CRPs may be associated with exiting a location, entering a location, at a previous location, at a target location, etc.

In step 503, the context platform 103 may determine one or more predicted contexts based on the chronological ordering. Using the models generated in step 501 above, the context platform 103 may determine predicted and/or future information regarding the user. For example, given the present time and location of the user, the context platform 103 may determine a predicted location that the user may travel to and the route the user may take to travel to the location. Thus, the context platform 103 may generate one or more models that allows for the determination of features of the user based on one or more streams of contextual information, such as a stream of location based contextual information. Based on the models, the context platform 103 can provide the delivery and/or execution of functionality at the UE 101. Such functionality may be related to one or more settings, one or more preferences, one or more applications, etc. By way of example, the user may assign a reminder application 111b to display a set reminder based on a transition between locations. For example, the user may set a reminder that is based on the context platform 103 determining that the user is about to transition to a set location.

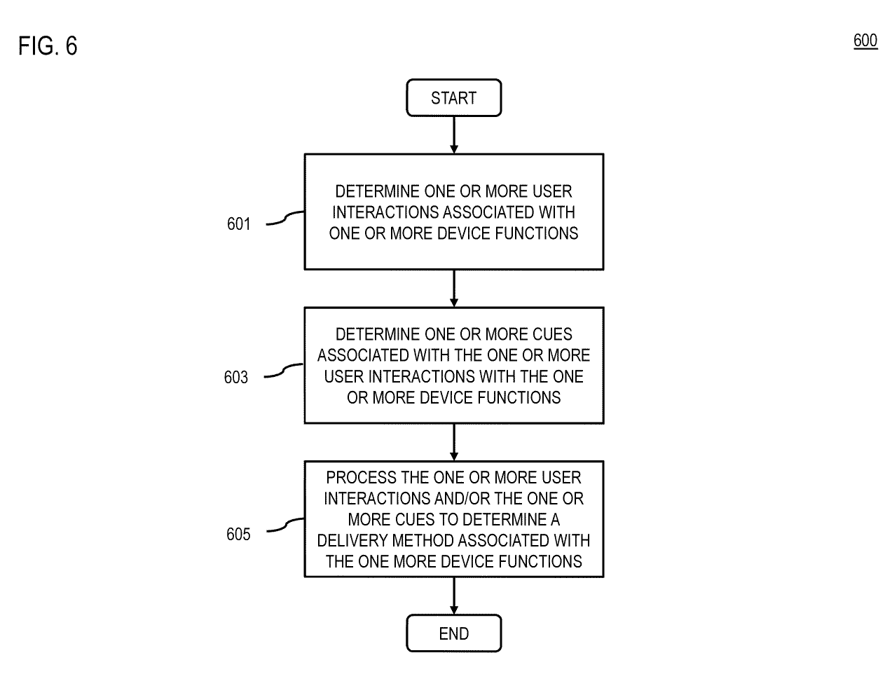

FIG. 6 is a flowchart of a process for determining one or more delivery methods for one or more device functions, according to one embodiment. In one embodiment, the context platform 103 performs the process 600 and is implemented in, for instance, a chip set including a processor and a memory as shown in FIG. 18. In step 601, the context platform 103 determines one or more user interactions associated with one or more device functions, the one or more device functions based, at least in part, on the one or more predicted contexts. The context platform 103 monitors the interactions with the functionality to determine whether the user accepts and/or dismisses the functionality. For example, where the functionality is a reminder, the context platform 103 monitors whether the user accepts and/or dismisses the reminder. In one embodiment, the context platform 103 determines whether the actions that dismiss and/or accept the functionality are associated with fast and/or slow responses.

In step 603, the context platform 103 determines one or more cues associated with the one or more user interactions with the one or more device functions. When the user interacts with the provided functionality, whether the interactions are dismissals and/or acceptances of the functionality and whether the interactions are fast and/or slow in response to the functionality, the context platform 103 monitors the contextual information associated with the interactions to determine one or more cues. The cues may be used to determine the types of interactions. By way of example, a cue may be associated with the user being on a phone call using the UE 101a. Based on this context, the user may dismiss the functionality or have a long delay before accepting the functionality. This cue of being on the phone may be learned by the system as a negative cue to avoid the delivery of the message during phone calls. Other cues may exist that are positive cues. For example, if audio signals are low and accelerometer information is small, the user may quickly respond to the functionality and accept, rather than dismiss, the functionality. These cues may be determined to be positive cues that indicate that the user is able to respond to the functionality and that the context platform 103 should provide the functionality. In one embodiment, the context platform 103 may monitor the interactions and determine cues categorized by the features, the feature anchors, the feature profiles, and the user profiles that are used to define the presentation and/or delivery of the functionality.

In step 605, the context platform 103 processes the one or more user interactions, the one or more cures, or a combination thereof to determine a delivery method associated with the one more device functions. The context platform 103 determines the interactions and the associated cues that correlate to fast versus slow responses, as well as dismissals versus acceptances. Based on the interactions and the cues, the context platform 103 may determine a delivery method for functionality at the UE 101. If functionality is important, the context platform 103 may determine cues that will provide a prompt acceptance of the functionality. If the functionality is not important, the context platform 103 may provide the functionality on the basis of cues that may result in a slow acceptance. Accordingly, the context platform 103 can provide contextually sensitive delivery of functionality.

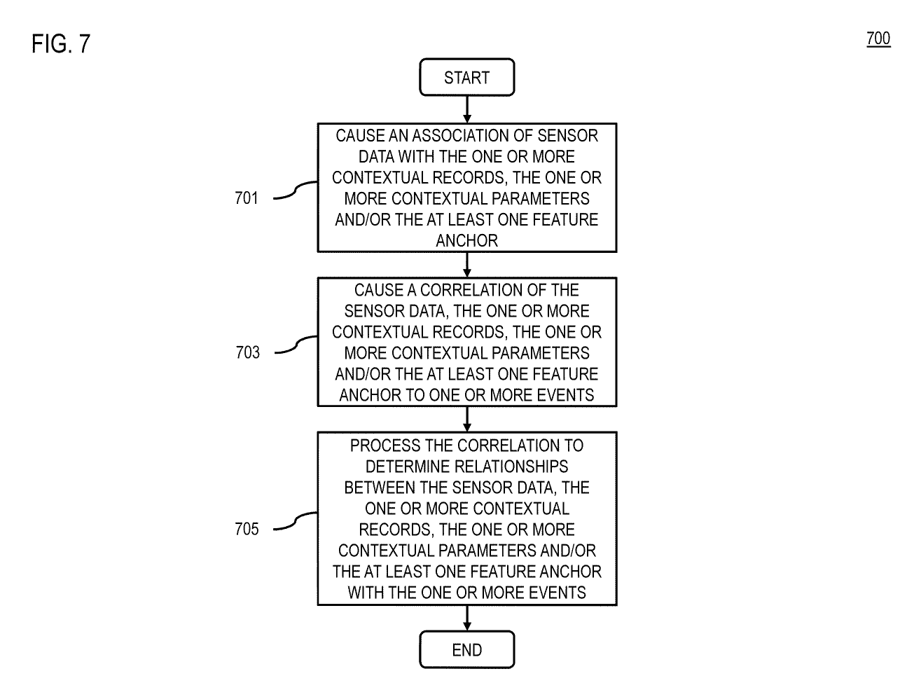

FIG. 7 is a flowchart of a process for determining one or more relationships between one or more news events and contextual information and/or sensor data, according to one embodiment. In one embodiment, the context platform 103 performs the process 700 and is implemented in, for instance, a chip set including a processor and a memory as shown in FIG. 18. In step 701, the context platform 103 causes, at least in part, an association of the sensor data with the one or more contextual records, the one or more contextual parameters, the at least one feature anchor, or a combination thereof. The UE 101 may continuously collect contextual information, such as the current location of the UE 101, current audio and/or light conditions, current acceleration readings, etc. The UE 101 may also collect additional information, such as sensor data. The sensor data may come from one or more of the sensors 115. For example, one of the sensors may be a camera. The camera may acquire one or more images of the surroundings of the UE 101. The images do not necessarily constitute contextual information. However, the one or more images do constitute sensor data that may be tagged according to the contextual information, such as being tagged as associated with a location, in proximity with one or more devices, etc. In step 701, the context platform 103 correlates the sensor data with the contextual information, in the form of the features, the feature anchors, the contextual parameters, the contextual records, etc. so as to further define the sensor data. By way of example, if an image acquired by a camera is correlated to the contextual information, the image may be geo-tagged according to the location in which the image was taken.

In step 703, the context platform 103 causes, at least in part, a correlation of the sensor data, the one or more contextual records, the one or more contextual parameters, the at least one feature anchor, or a combination thereof to one or more events. As discussed above, the context platform 103 may determine one or more events. The events may be determined automatically and/or the event may be user nominated/generated. The context platform 103 may associate the collected contextual information and/or the sensor data with the collected events. In one embodiment, the context platform 103 may continuously store contextual information and/or the sensor data within a buffer. Once an event is determined, the context platform 103 and/or the user may determine to associate the event with the stored contextual information and/or the sensor data. Alternatively, as the event is determined, the contextual information and/or the sensor data that is currently active and/or present at the time of the event may be associated with the event.

In step 705, the context platform 103 processes the correlation to determine one or more relationships between the sensor data, the one or more contextual records, the one or more contextual parameters, the at least one feature anchor, or a combination thereof and the one or more events. The context platform 103 may process the contextual information and/or the sensor data to determine one or more patterns in the sensor data and/or determine one or more feature anchors and/or contextual parameters that have a correlation with the one or more events. The contextual information and/or the sensor data that have a correlation with the one or more events may be associated with the events such that there is a relationship between the events and the contextual information and/or the sensor data.

By way of example, certain diseases are spread with people traveling to different locations over short periods of time. Such diseases may be responsible for global epidemics. In this case, certain sensor data, such as information from a thermometer associated with the UE 101, may be correlated with the symptoms and the spread of the disease based on, for example, news events reporting locations of the disease correlated with locations to where user has traveled. The correlation made by the context platform 103 may indicate that the user may be suffering from the diseases and/or the user could be alerted to certain travel warnings and/or conditions related to the spread of the disease based on the correlation of the sensor data and/or contextual information with the event regarding the disease. In one embodiment, this information may be acquired over successive iterations between the sensor data and/or contextual information with the news events until patterns form that have an associated semantic description that may be understood by a user and/or the context platform 103, and subsequently used to semantically classify additional or future sensor data and/or context information.

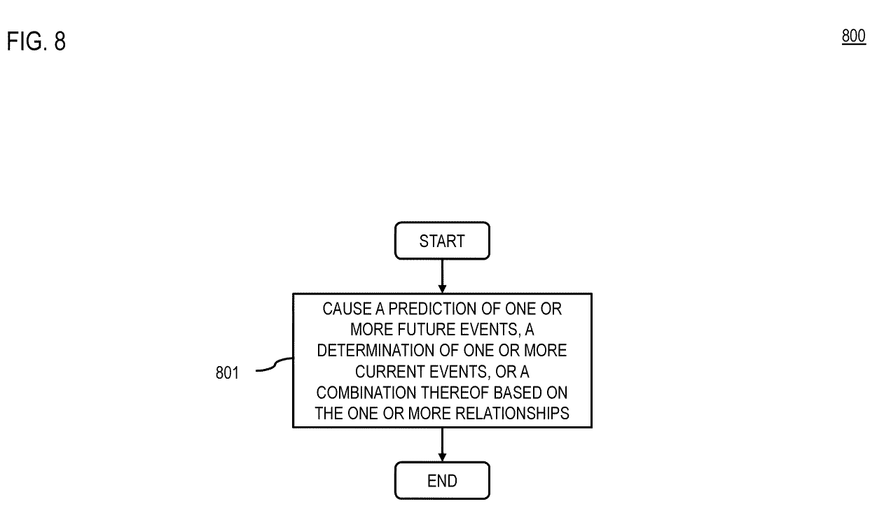

FIG. 8 is a flowchart of a process for determining one or more current events and/or one or more predicted future events based on the relationships, according to one embodiment. In one embodiment, the context platform 103 performs the process 800 and is implemented in, for instance, a chip set including a processor and a memory as shown in FIG. 18. In step 801, the context platform 103 causes, at least in part, a prediction of one or more future events, a determination of one or more current events, or a combination thereof based, at least in part, on the one or more relationships. The context platform 103 may detect contextual information and/or sensor data and classify the contextual information and/or sensor data based on the contextual information and/or sensor data that was used above to correlate to one or more events. If a match is found between the current contextual information and/or the sensor data with the previously determined and correlated contextual information and sensor data, the context platform 103 may tag the current contextual information and/or sensor data with the semantics of the correlated one or more events. If there is no match found, the context platform 103 may store the current contextual information and/or sensor data for later processing and/or correlation with one or more events.

By way of example, a sensor 115a associated with the UE 101 may detect one or more gases. Based on this sensor data, the context platform 103 may match the sensor data with other sensor data stored in the contextual records database 117. If there is a match, the sensor data may be correlated with the previously matched event. By way of example, the event may correspond to an earthquake and the sensor data may correspond to a gas that may be emitted by the ground moments prior to the earthquake. The context platform 103 may detect the sensor data associated with the gas and match the sensor data with sensor data stored in the contextual records database 117 that was already correlated with the event of an earthquake. Accordingly, upon detecting the gas, the context platform 103 may determine that there is an earthquake that may be moments from occurring. However, if there is no match with sensor data stored in the contextual records database 117, the context platform 103 may store the sensor data for a later correlation of the data with one or more events.

In one embodiment, upon detecting the contextual information and/or sensor data, the context platform 103 may prompt the user of the UE 101a associated with the sensor if the user would like to analyze the contextual information and/or sensor data against the stored contextual information and/or sensor data. In one embodiment, the context platform 103 prompts whether to analyze the contextual information and/or the sensor data if the context platform 103 detects an anomaly within the contextual information and/or sensor data. The anomaly may be represented by one or more features satisfying a certain threshold, one or more features that normally are not found in the contextual information and/or sensor data being found in the information, or a combination thereof.

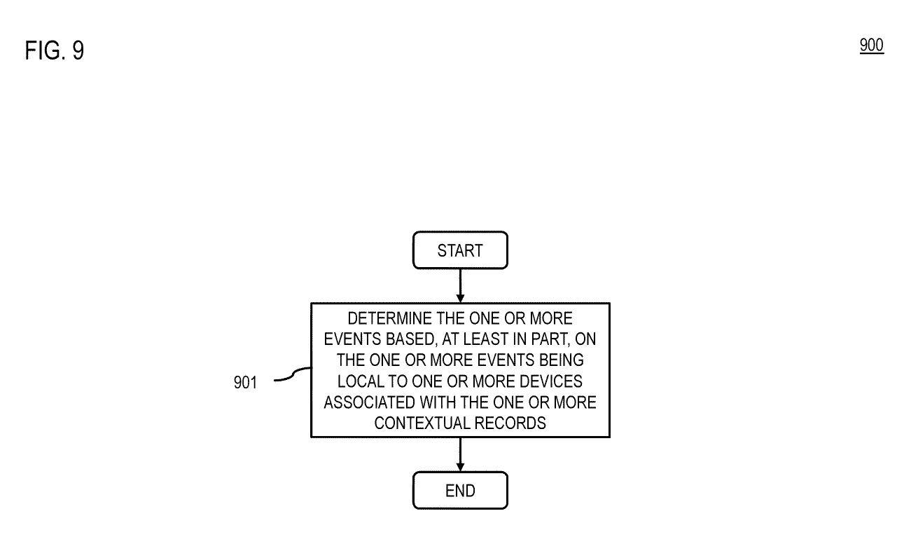

FIG. 9 is a flowchart of a process for determining one or more events, according to one embodiment. In one embodiment, the context platform 103 performs the process 900 and is implemented in, for instance, a chip set including a processor and a memory as shown in FIG. 18. In step 901, the context platform 103 determines the one or more events based, at least in part, on the one or more events being local to one or more devices associated with the one or more contextual records. The one or more events are local to the one or more devices such that the contextual information and sensor data acquired by the one or more devices, such as the UE 101 by way of the one or more applications 111, one or more sensors 115, etc., pertains to the one or more events. By way of example, an event may be an earthquake. If the earthquake is not local to a specific UE 101a, the contextual information and/or sensor data acquired by the UE 101a will not pertain to the earthquake. Thus, processing the contextual information and/or sensor data acquired by the UE 101a will not reveal patterns with the earthquake. However, if the earthquake is local to the specific UE 101a, the contextual information and/or sensor data acquired by the UE 101a may include patterns that are associated with the earthquake that may be determined over iterations of comparing other contextual information and/or sensor data resulting from other earthquakes.

As discussed above, the one or more events may be gathered by any method, such as through one or more content providers 113 (e.g., global news providers) and through one or more services 109 (e.g., news event providers, social networking messages, weather information services, geological information services, etc.). The one or more events may also be generated by the user at the UE 101a through, for example, one or more applications (e.g., diary, health monitoring application, etc.). In one embodiment, the context platform 103 may monitor communications between the UE 101a and other elements of the system 100 to determine events from the one or more communications. For example, the context platform 103 may monitor SMS, MMS, and email communications. One or more communications may indicate an event, such as an SMS message indicating that someone just had a heart attack, for example. Patterns over many communications may indicate an event, such as where the context platform 103 determines a large number of communications that include similar semantic information, such as observations regarding a particular phenomenon that all include similar keywords. Thus, the collected news events may be gathered and/or generated from many different sources.

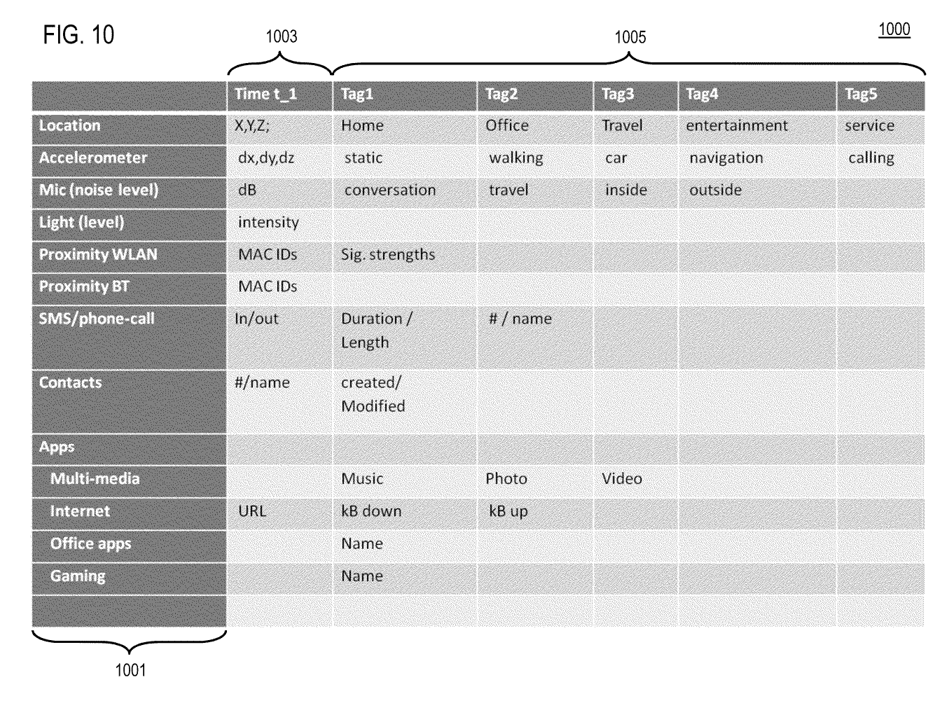

FIG. 10 is a diagram of contextual records 1000 that may be stored in the contextual records database 117, according to one embodiment. The contextual records 1000 may include one or more contextual parameters 1001. The contextual parameters 1001 may include, for example, location, accelerometer, noise levels, light levels, proximity information associated with WLAN and/or Bluetooth®, incoming/outgoing communication records, contacts, and information regarding one or more applications 111. The contextual records may further include multiple entries divided by time stamps 1003. Although only one entry Time t_1 is illustrated in FIG. 10, the contextual records may include a plurality of entries Time t_1 to Time t_n. Each one of the time entries 1003 may include features that constitute values associated with the contextual parameters 1001. In one embodiment, each time entry 1003 includes features for all of the contextual parameters 1001 that may be determined based on the ability to collect the information (e.g., based on the presence of the sensors 115, the applications 111, the services 109, and/or content providers 113). Each feature according to the contextual parameter 1001 and the time stamp 1003 may include one or more tags 1005. As illustrated, the location contextual parameter may include the tags X,Y,Z (e.g., the location) and a description of the location (e.g., Home, Office, Travel, Entertainment, Service, etc.). Similarly, the accelerometer contextual parameter may include the tags dx, dy, dz (e.g., the acceleration readings from one of the sensors 115) and a description of the movement (e.g., static, walking, car, navigation, calling, etc.). In one embodiment, one or more of the tags may be associated with a feature anchor tag that indicates that the contextual parameter is a feature anchor and/or associated with a feature anchor.

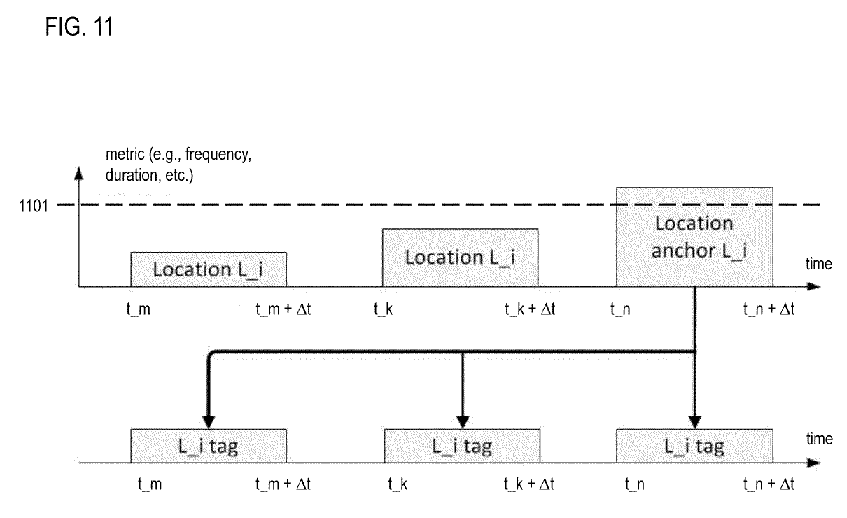

FIG. 11 is a diagram illustrating the tagging of one or more features of a contextual parameter based on a feature anchor, according to one embodiment. Specifically, FIG. 11 illustrates the determination that a location contextual parameter constitutes a feature anchor. As illustrated, during time periods t_m+Δt, t_k+Δt, and t_n+Δt, the user may have been in location L_i. Thus, these time periods are stored in the contextual records along with other contextual information and/or sensor data that may have been acquired during the same time periods Δt. Only during time period t_n+Δt did the feature satisfy a given metric (e.g., a threshold). For example, the metric may have been a certain duration within the time period t_n+Δt that a location was determined. Once the feature anchor L_i is determined, the context platform 103 may tag the contextual parameters associated with the time period t_n+Δt as being associated with a feature anchor. Further, the context platform 103 may tag other location contextual parameters stored in the contextual records that include the location feature L_i as being associated with a feature anchor. Thus, time periods t_m+Δt and t_k+Δt are also tagged as being associated with the feature anchor L_i.

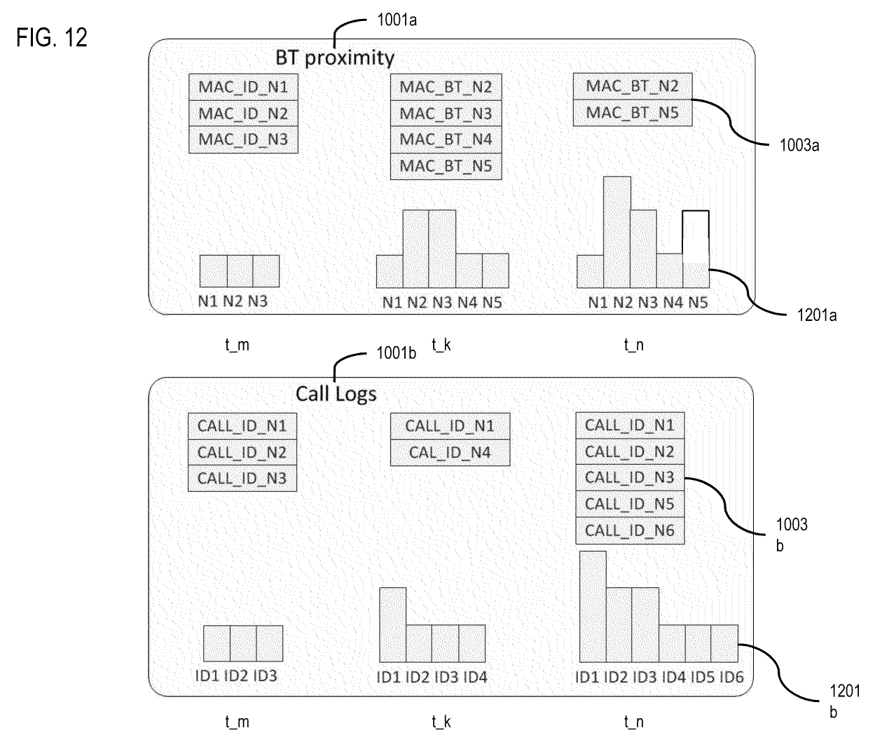

FIG. 12 is a diagram of histograms for determining one or more related contextual parameters to a feature anchor, according to one embodiment. The time periods t_m+Δt, t_k+Δt, and t_n+Δt may include information regarding devices that were in the proximity of the UE 101a that acquired the contextual information during the time periods, associated with the contextual parameter 1001a, as well as calls that were placed within the time periods, associated with the contextual parameter 1001b. The context platform 103 may generate histograms 1201a and 1201b of the contextual parameters 1001a and 1001b that are based on the features for the contextual parameters 1001a and 1001b at the time periods that are associated with the feature anchor. As illustrated in FIG. 12, the UE 101a that acquired the contextual information was commonly in proximity with devices N2, N3 and N5 during the time periods associated with the feature anchor, an commonly called ID numbers 1, 2 and 3.

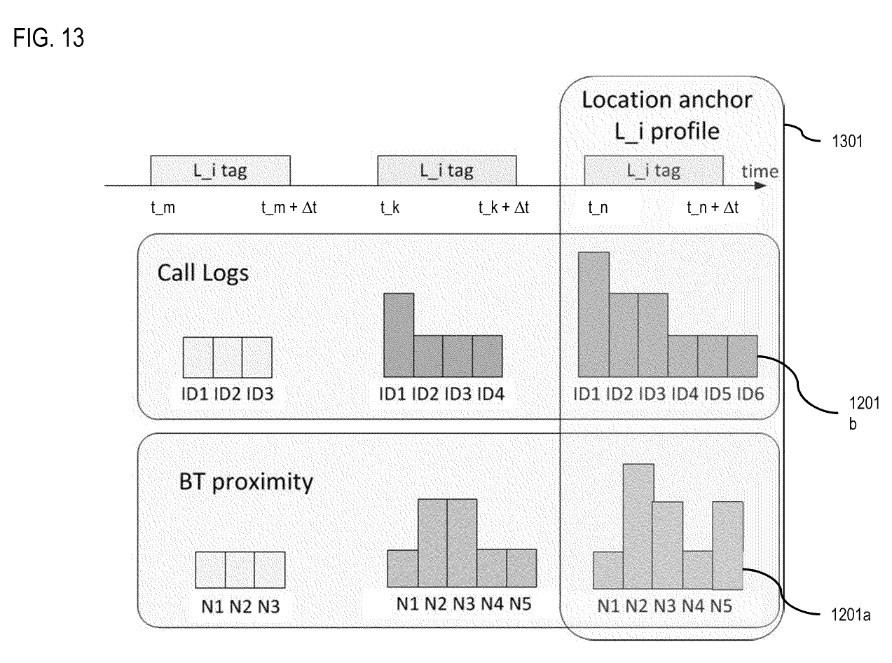

FIG. 13 is a diagram illustrating the formation of a feature profile 1301 based on related contextual parameters associated with a feature anchor, according to one embodiment. The feature profile 1301 may include the feature anchor and the contextual parameters that are associated with the feature anchor, such as the context parameters associated with the histograms 1201a and 1201b. The feature profile 1301 indicates that, when the user associated with the UE 101a is in the location L_i associated with the feature anchor, the user primarily calls IDs 1-3 and is in proximity to devices N2, N3 and N5. This information constitutes a feature profile. Thus, the context platform 103 may use the feature profile to generate one or more predictions, such as when the user is in location L_i, there is a high probability that the user will be in close proximity to devices N2, N3 and N5 and that the user will likely call IDs 1-3. Based on this information, the context platform 103 may cause the UE 101 to control one or more functionalities and/or provide one or more services at the UE 101a. Additionally, the context platform 103 may assign an activity to the feature profile based on the features associated with the profile, such as the location of the profile and/or the devices in proximity and/or communication with the UE 101a. In one embodiment, the context platform 103 allows the user of the UE 101a to name the location associated with the feature profile, the feature profile itself and/or an activity associated with the profile.

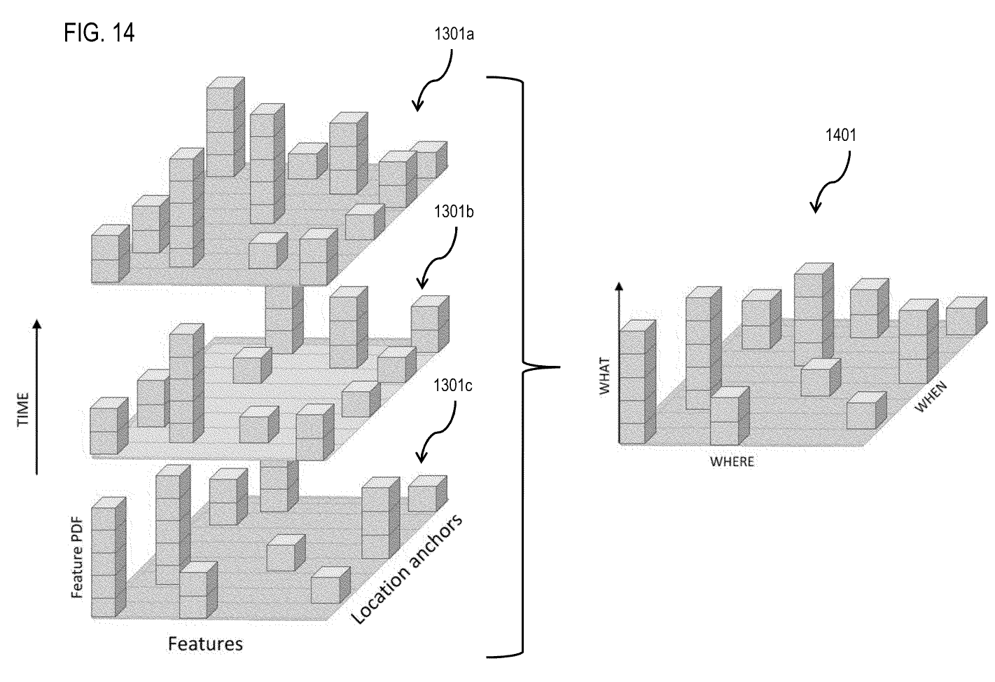

FIG. 14 is a diagram of a user profile 1401, according to one embodiment. The user profile 1401 may be a combination of many feature profiles 1301a-1301c. As illustrated, the feature profiles 1301a-1301c may include multiple feature anchors that are used to create the feature profiles 1301a-1301c. The user profile 1401 is therefore a combination of the multiple feature profiles 1301a-1301c that are associated with a user and/or device.

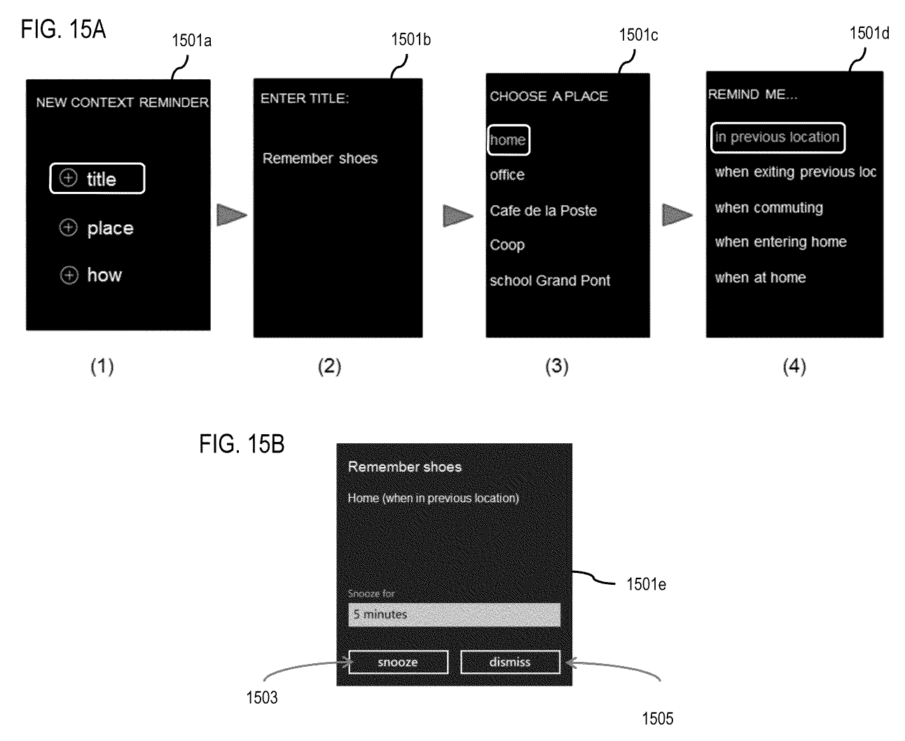

FIGS. 15A and 15B are diagrams of user interfaces utilized in the processes of FIGS. 5 and 6, according to various embodiments. FIG. 15A illustrates user interfaces 1501a-1501d used in the process of setting a contextually sensitive reminder. As illustrated in the user interface 1501a, a user may specify a title, a location and how the reminder should be delivered. As illustrated in the user interface 1501b, the user may enter the title Remember shoes so that the user is reminded to remember his/her shoes. As illustrated in the user interface 1501c, the user may select from one or more locations that is associated with triggering the reminder. In this instance, the user selected the location home to be associated with the reminder. In one embodiment, as the user is associated with more contextual information, the user may be able to choose more locations. In one embodiment, the user may enter locations on their own, independent of the contextual information indicating the importance of a location prior to the location being added to the list illustrated by the user interface 1501c. User interface 1501d illustrates the ability to select a chronological reference point (CRP) associated with the reminder. The user may select from: in previous location, when exiting previous location, when commuting, when entering home and when at home. The selected CRP of in previous location will trigger the reminder of Remember shoes when the user is in a location that is predicted as being prior to the user being at home. Thus, according to the configuration illustrated in FIG. 15A regarding the user interfaces 1501a-1501d, the user may set various reminders associated with various locations that are triggered according to various CRPs. However, the user interfaces 1501a-1501d may be associated with any type of feature (e.g., a feature other than location) and any type of CRP related to the features.

FIG. 15B illustrates a reminder that may be associated with the reminder set in FIG. 15A. As illustrated, a user interface 1501e includes the reminder Remember shoes, the associated location of the reminder (e.g., Home) and the associated CRP of the reminder (e.g., when in previous location). The user interface 1501e may also include a snooze indicator 1503 and a dismiss indicator 1505. The snooze indicator 1503 may cause the reminder to be dismissed for a given time interval (e.g., 5 minutes). The dismiss indicator 1505 may cause the reminder to be dismissed permanently. Based on the user's interactions with the indicators 1503 and 1505, the context platform 103 may determine certain cues that indicate a fast/slow and/or dismiss/accept response to the reminder.

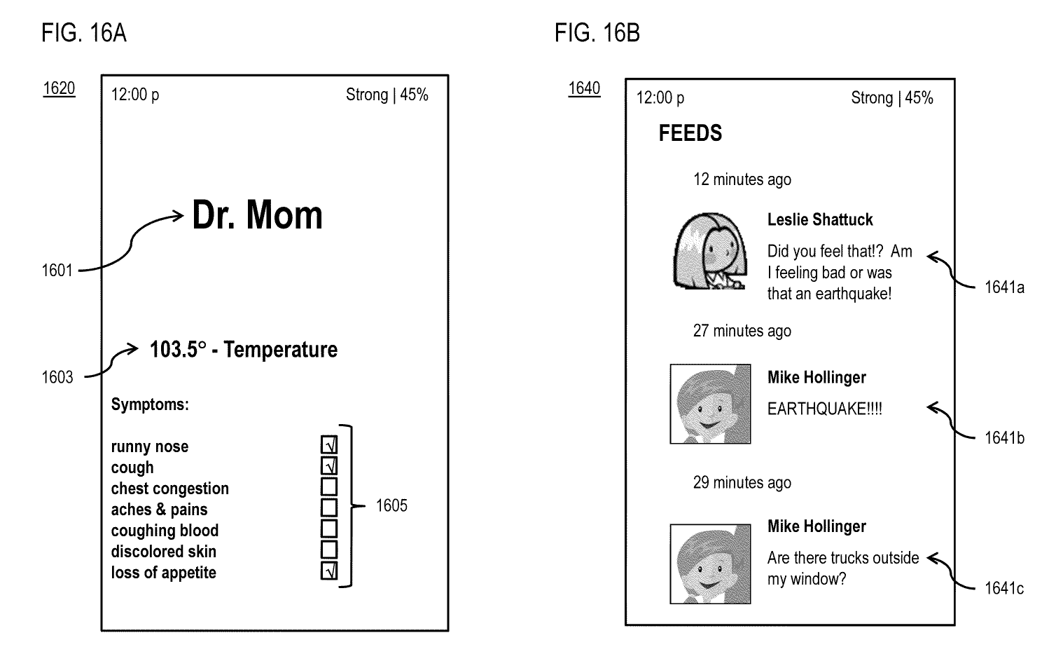

FIGS. 16A and 16B are diagrams of user interfaces utilized in the processes of FIGS. 7-9, according to various embodiments. FIG. 16A illustrates the user interface 1620 associated with a UE 101a executing an application 111a that may be connected to or associated with a thermometer (e.g., a sensor 115) that is wirelessly connected to the UE 101a. Indicator 1601 may indicate the name of the application Dr. Mom. The application 111a may provide for the ability to read the temperature reading 1603 from the thermometer on the user interface 1620 of the UE 101a. As illustrated, the temperature reading is 103.5°. The user interface 1620 may also include one or more symptom indicators 1605. The symptom indicates 1605 allow for the user of the UE 101a to further diagnose their sickness. By way of example, the user of the UE 101a experiencing the fever of 103.5° is also experiencing a runny nose, cough and loss of appetite. The information represented by the user interface 1620, including the temperature reading 1603 and the symptom indicators 1605 may represent sensor data that is collected at the UE 101 and that may be subsequently correlated with contextual information and/or events. By way of example, the temperature reading 1603 and the symptom indicators 1605 may be correlated with the current location of the UE 101a and a news event indicating that there is a current outbreak of a dangerous disease. Based on the correlation of the sensor data, the contextual information, and the symptom indicators, the user of the UE 101a may have a better understanding of whether to visit the doctor.

FIG. 16B illustrates a user interface 1640 associated with a social networking application 111b that interfaces with one or more social networking services 109. The user interface 1640 may include social networking messages 1641a-1641c. As illustrated, the social networking messages 1641a-1641c all relate to a current event that has occurred, specifically an earthquake. The context platform 103 may analyze the social networking messages 1641a-1641c to determine one or more events to correlate to sensor data and/or contextual information. Accordingly, based on the illustrated social networking messages 1641a-1641c, the context platform 103 may determine an event related to the earthquake that the context platform 103 may subsequently process.

The processes described herein for providing intelligent processing of contextual information may be advantageously implemented via software, hardware, firmware or a combination of software and/or firmware and/or hardware. For example, the processes described herein, may be advantageously implemented via processor(s), Digital Signal Processing (DSP) chip, an Application Specific Integrated Circuit (ASIC), Field Programmable Gate Arrays (FPGAs), etc. Such exemplary hardware for performing the described functions is detailed below.

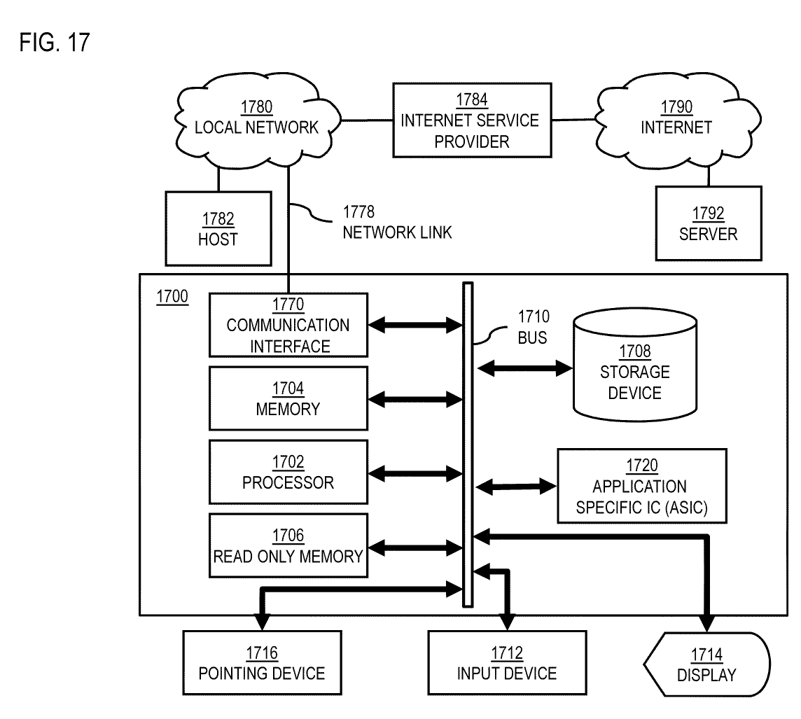

FIG. 17 illustrates a computer system 1700 upon which an embodiment of the invention may be implemented. Although computer system 1700 is depicted with respect to a particular device or equipment, it is contemplated that other devices or equipment (e.g., network elements, servers, etc.) within FIG. 17 can deploy the illustrated hardware and components of system 1700. Computer system 1700 is programmed (e.g., via computer program code or instructions) to provide providing intelligent processing of contextual information as described herein and includes a communication mechanism such as a bus 1710 for passing information between other internal and external components of the computer system 1700. Information (also called data) is represented as a physical expression of a measurable phenomenon, typically electric voltages, but including, in other embodiments, such phenomena as magnetic, electromagnetic, pressure, chemical, biological, molecular, atomic, sub-atomic and quantum interactions. A sequence of one or more digits constitutes digital data that is used to represent a number or code for a character. In some embodiments, information called analog data is represented by a near continuum of measurable values within a particular range. Computer system 1700, or a portion thereof, constitutes a means for performing one or more steps of providing intelligent processing of contextual information.

A bus 1710 includes one or more parallel conductors of information so that information is transferred quickly among devices coupled to the bus 1710. One or more processors 1702 for processing information are coupled with the bus 1710.

A processor (or multiple processors) 1702 performs a set of operations on information as specified by computer program code related to providing intelligent processing of contextual information. The computer program code is a set of instructions or statements providing instructions for the operation of the processor and/or the computer system to perform specified functions. The code, for example, may be written in a computer programming language that is compiled into a native instruction set of the processor. The code may also be written directly using the native instruction set (e.g., machine language). The set of operations include bringing information in from the bus 1710 and placing information on the bus 1710. The set of operations also typically include comparing two or more units of information, shifting positions of units of information, and combining two or more units of information, such as by addition or multiplication or logical operations like OR, exclusive OR (XOR), and AND. Each operation of the set of operations that can be performed by the processor is represented to the processor by information called instructions, such as an operation code of one or more digits. A sequence of operations to be executed by the processor 1702, such as a sequence of operation codes, constitute processor instructions, also called computer system instructions or, simply, computer instructions. Processors may be implemented as mechanical, electrical, magnetic, optical, chemical or quantum components, among others, alone or in combination.

Computer system 1700 also includes a memory 1704 coupled to bus 1710. The memory 1704, such as a random access memory (RAM) or any other dynamic storage device, stores information including processor instructions for providing intelligent processing of contextual information. Dynamic memory allows information stored therein to be changed by the computer system 1700. RAM allows a unit of information stored at a location called a memory address to be stored and retrieved independently of information at neighboring addresses. The memory 1704 is also used by the processor 1702 to store temporary values during execution of processor instructions. The computer system 1700 also includes a read only memory (ROM) 1706 or any other static storage device coupled to the bus 1710 for storing static information, including instructions, that is not changed by the computer system 1700. Some memory is composed of volatile storage that loses the information stored thereon when power is lost. Also coupled to bus 1710 is a non-volatile (persistent) storage device 1708, such as a magnetic disk, optical disk or flash card, for storing information, including instructions, that persists even when the computer system 1700 is turned off or otherwise loses power.

Information, including instructions for providing intelligent processing of contextual information, is provided to the bus 1710 for use by the processor from an external input device 1712, such as a keyboard containing alphanumeric keys operated by a human user, a microphone, an Infrared (IR) remote control, a joystick, a game pad, a stylus pen, a touch screen, or a sensor. A sensor detects conditions in its vicinity and transforms those detections into physical expression compatible with the measurable phenomenon used to represent information in computer system 1700. Other external devices coupled to bus 1710, used primarily for interacting with humans, include a display device 1714, such as a cathode ray tube (CRT), a liquid crystal display (LCD), a light emitting diode (LED) display, an organic LED (OLED) display, a plasma screen, or a printer for presenting text or images, and a pointing device 1716, such as a mouse, a trackball, cursor direction keys, or a motion sensor, for controlling a position of a small cursor image presented on the display 1714 and issuing commands associated with graphical elements presented on the display 1714. In some embodiments, for example, in embodiments in which the computer system 1700 performs all functions automatically without human input, one or more of external input device 1712, display device 1714 and pointing device 1716 is omitted.

In the illustrated embodiment, special purpose hardware, such as an application specific integrated circuit (ASIC) 1720, is coupled to bus 1710. The special purpose hardware is configured to perform operations not performed by processor 1702 quickly enough for special purposes. Examples of ASICs include graphics accelerator cards for generating images for display 1714, cryptographic boards for encrypting and decrypting messages sent over a network, speech recognition, and interfaces to special external devices, such as robotic arms and medical scanning equipment that repeatedly perform some complex sequence of operations that are more efficiently implemented in hardware.

Computer system 1700 also includes one or more instances of a communications interface 1770 coupled to bus 1710. Communication interface 1770 provides a one-way or two-way communication coupling to a variety of external devices that operate with their own processors, such as printers, scanners and external disks. In general the coupling is with a network link 1778 that is connected to a local network 1780 to which a variety of external devices with their own processors are connected. For example, communication interface 1770 may be a parallel port or a serial port or a universal serial bus (USB) port on a personal computer. In some embodiments, communications interface 1770 is an integrated services digital network (ISDN) card or a digital subscriber line (DSL) card or a telephone modem that provides an information communication connection to a corresponding type of telephone line. In some embodiments, a communication interface 1770 is a cable modem that converts signals on bus 1710 into signals for a communication connection over a coaxial cable or into optical signals for a communication connection over a fiber optic cable. As another example, communications interface 1770 may be a local area network (LAN) card to provide a data communication connection to a compatible LAN, such as Ethernet. Wireless links may also be implemented. For wireless links, the communications interface 1770 sends or receives or both sends and receives electrical, acoustic or electromagnetic signals, including infrared and optical signals, that carry information streams, such as digital data. For example, in wireless handheld devices, such as mobile telephones like cell phones, the communications interface 1770 includes a radio band electromagnetic transmitter and receiver called a radio transceiver. In certain embodiments, the communications interface 1770 enables connection to the communication network 105 for providing intelligent data processing at the UE 101.

The term “computer-readable medium” as used herein refers to any medium that participates in providing information to processor 1702, including instructions for execution. Such a medium may take many forms, including, but not limited to computer-readable storage medium (e.g., non-volatile media, volatile media), and transmission media. Non-transitory media, such as non-volatile media, include, for example, optical or magnetic disks, such as storage device 1708. Volatile media include, for example, dynamic memory 1704. Transmission media include, for example, twisted pair cables, coaxial cables, copper wire, fiber optic cables, and carrier waves that travel through space without wires or cables, such as acoustic waves and electromagnetic waves, including radio, optical and infrared waves. Signals include man-made transient variations in amplitude, frequency, phase, polarization or other physical properties transmitted through the transmission media. Common forms of computer-readable media include, for example, a floppy disk, a flexible disk, hard disk, magnetic tape, any other magnetic medium, a CD-ROM, CDRW, DVD, any other optical medium, punch cards, paper tape, optical mark sheets, any other physical medium with patterns of holes or other optically recognizable indicia, a RAM, a PROM, an EPROM, a FLASH-EPROM, an EEPROM, a flash memory, any other memory chip or cartridge, a carrier wave, or any other medium from which a computer can read. The term computer-readable storage medium is used herein to refer to any computer-readable medium except transmission media.

Logic encoded in one or more tangible media includes one or both of processor instructions on a computer-readable storage media and special purpose hardware, such as ASIC 1720.

Network link 1778 typically provides information communication using transmission media through one or more networks to other devices that use or process the information. For example, network link 1778 may provide a connection through local network 1780 to a host computer 1782 or to equipment 1784 operated by an Internet Service Provider (ISP). ISP equipment 1784 in turn provides data communication services through the public, world-wide packet-switching communication network of networks now commonly referred to as the Internet 1790.

A computer called a server host 1792 connected to the Internet hosts a process that provides a service in response to information received over the Internet. For example, server host 1792 hosts a process that provides information representing video data for presentation at display 1714. It is contemplated that the components of system 1700 can be deployed in various configurations within other computer systems, e.g., host 1782 and server 1792.

At least some embodiments of the invention are related to the use of computer system 1700 for implementing some or all of the techniques described herein. According to one embodiment of the invention, those techniques are performed by computer system 1700 in response to processor 1702 executing one or more sequences of one or more processor instructions contained in memory 1704. Such instructions, also called computer instructions, software and program code, may be read into memory 1704 from another computer-readable medium such as storage device 1708 or network link 1778. Execution of the sequences of instructions contained in memory 1704 causes processor 1702 to perform one or more of the method steps described herein. In alternative embodiments, hardware, such as ASIC 1720, may be used in place of or in combination with software to implement the invention. Thus, embodiments of the invention are not limited to any specific combination of hardware and software, unless otherwise explicitly stated herein.

The signals transmitted over network link 1778 and other networks through communications interface 1770, carry information to and from computer system 1700. Computer system 1700 can send and receive information, including program code, through the networks 1780, 1790 among others, through network link 1778 and communications interface 1770. In an example using the Internet 1790, a server host 1792 transmits program code for a particular application, requested by a message sent from computer 1700, through Internet 1790, ISP equipment 1784, local network 1780 and communications interface 1770. The received code may be executed by processor 1702 as it is received, or may be stored in memory 1704 or in storage device 1708 or any other non-volatile storage for later execution, or both. In this manner, computer system 1700 may obtain application program code in the form of signals on a carrier wave.

Various forms of computer readable media may be involved in carrying one or more sequence of instructions or data or both to processor 1702 for execution. For example, instructions and data may initially be carried on a magnetic disk of a remote computer such as host 1782. The remote computer loads the instructions and data into its dynamic memory and sends the instructions and data over a telephone line using a modem. A modem local to the computer system 1700 receives the instructions and data on a telephone line and uses an infra-red transmitter to convert the instructions and data to a signal on an infra-red carrier wave serving as the network link 1778. An infrared detector serving as communications interface 1770 receives the instructions and data carried in the infrared signal and places information representing the instructions and data onto bus 1710. Bus 1710 carries the information to memory 1704 from which processor 1702 retrieves and executes the instructions using some of the data sent with the instructions. The instructions and data received in memory 1704 may optionally be stored on storage device 1708, either before or after execution by the processor 1702.

FIG. 18 illustrates a chip set or chip 1800 upon which an embodiment of the invention may be implemented. Chip set 1800 is programmed to provide providing intelligent processing of contextual information as described herein and includes, for instance, the processor and memory components described with respect to FIG. 17 incorporated in one or more physical packages (e.g., chips). By way of example, a physical package includes an arrangement of one or more materials, components, and/or wires on a structural assembly (e.g., a baseboard) to provide one or more characteristics such as physical strength, conservation of size, and/or limitation of electrical interaction. It is contemplated that in certain embodiments the chip set 1800 can be implemented in a single chip. It is further contemplated that in certain embodiments the chip set or chip 1800 can be implemented as a single “system on a chip.” It is further contemplated that in certain embodiments a separate ASIC would not be used, for example, and that all relevant functions as disclosed herein would be performed by a processor or processors. Chip set or chip 1800, or a portion thereof, constitutes a means for performing one or more steps of providing user interface navigation information associated with the availability of functions. Chip set or chip 1800, or a portion thereof, constitutes a means for performing one or more steps of providing intelligent processing of contextual information.

In one embodiment, the chip set or chip 1800 includes a communication mechanism such as a bus 1801 for passing information among the components of the chip set 1800. A processor 1803 has connectivity to the bus 1801 to execute instructions and process information stored in, for example, a memory 1805. The processor 1803 may include one or more processing cores with each core configured to perform independently. A multi-core processor enables multiprocessing within a single physical package. Examples of a multi-core processor include two, four, eight, or greater numbers of processing cores. Alternatively or in addition, the processor 1803 may include one or more microprocessors configured in tandem via the bus 1801 to enable independent execution of instructions, pipelining, and multithreading. The processor 1803 may also be accompanied with one or more specialized components to perform certain processing functions and tasks such as one or more digital signal processors (DSP) 1807, or one or more application-specific integrated circuits (ASIC) 1809. A DSP 1807 typically is configured to process real-world signals (e.g., sound) in real time independently of the processor 1803. Similarly, an ASIC 1809 can be configured to performed specialized functions not easily performed by a more general purpose processor. Other specialized components to aid in performing the inventive functions described herein may include one or more field programmable gate arrays (FPGA), one or more controllers, or one or more other special-purpose computer chips.

In one embodiment, the chip set or chip 1800 includes merely one or more processors and some software and/or firmware supporting and/or relating to and/or for the one or more processors.

The processor 1803 and accompanying components have connectivity to the memory 1805 via the bus 1801. The memory 1805 includes both dynamic memory (e.g., RAM, magnetic disk, writable optical disk, etc.) and static memory (e.g., ROM, CD-ROM, etc.) for storing executable instructions that when executed perform the inventive steps described herein to provide providing intelligent processing of contextual information. The memory 1805 also stores the data associated with or generated by the execution of the inventive steps.

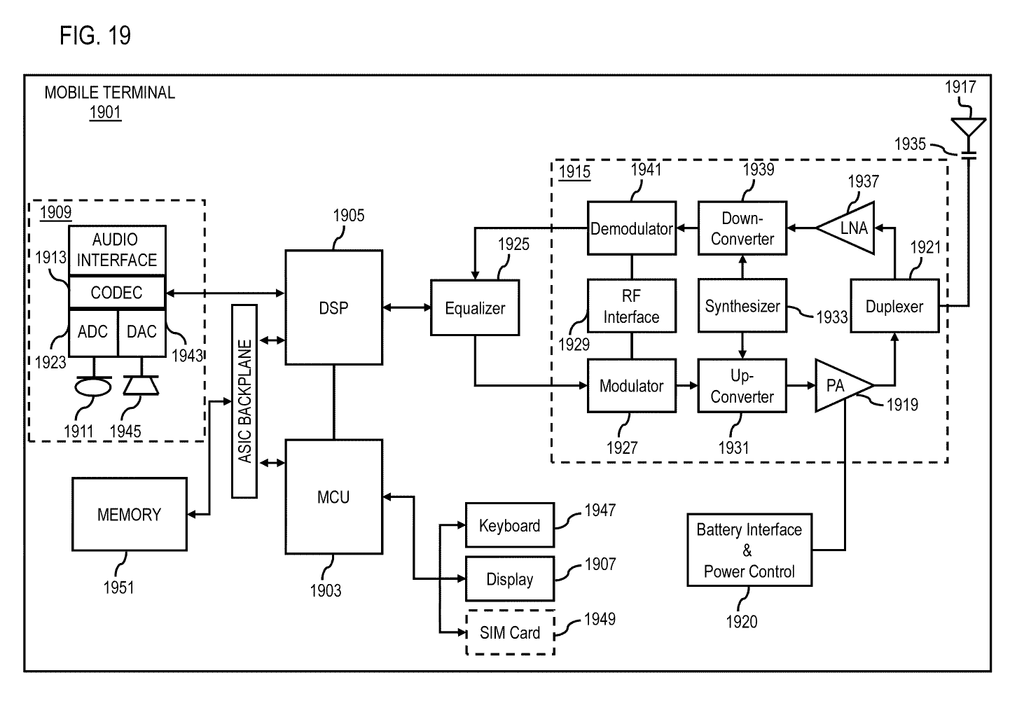

FIG. 19 is a diagram of exemplary components of a mobile terminal (e.g., handset) for communications, which is capable of operating in the system of FIG. 1, according to one embodiment. In some embodiments, mobile terminal 1901, or a portion thereof, constitutes a means for performing one or more steps of providing intelligent processing of contextual information. Generally, a radio receiver is often defined in terms of front-end and back-end characteristics. The front-end of the receiver encompasses all of the Radio Frequency (RF) circuitry whereas the back-end encompasses all of the base-band processing circuitry. As used in this application, the term “circuitry” refers to both: (1) hardware-only implementations (such as implementations in only analog and/or digital circuitry), and (2) to combinations of circuitry and software (and/or firmware) (such as, if applicable to the particular context, to a combination of processor(s), including digital signal processor(s), software, and memory(ies) that work together to cause an apparatus, such as a mobile phone or server, to perform various functions). This definition of “circuitry” applies to all uses of this term in this application, including in any claims. As a further example, as used in this application and if applicable to the particular context, the term “circuitry” would also cover an implementation of merely a processor (or multiple processors) and its (or their) accompanying software/or firmware. The term “circuitry” would also cover if applicable to the particular context, for example, a baseband integrated circuit or applications processor integrated circuit in a mobile phone or a similar integrated circuit in a cellular network device or other network devices.

Pertinent internal components of the telephone include a Main Control Unit (MCU) 1903, a Digital Signal Processor (DSP) 1905, and a receiver/transmitter unit including a microphone gain control unit and a speaker gain control unit. A main display unit 1907 provides a display to the user in support of various applications and mobile terminal functions that perform or support the steps of providing intelligent processing of contextual information. The display 1907 includes display circuitry configured to display at least a portion of a user interface of the mobile terminal (e.g., mobile telephone). Additionally, the display 1907 and display circuitry are configured to facilitate user control of at least some functions of the mobile terminal. An audio function circuitry 1909 includes a microphone 1911 and microphone amplifier that amplifies the speech signal output from the microphone 1911. The amplified speech signal output from the microphone 1911 is fed to a coder/decoder (CODEC) 1913.

A radio section 1915 amplifies power and converts frequency in order to communicate with a base station, which is included in a mobile communication system, via antenna 1917. The power amplifier (PA) 1919 and the transmitter/modulation circuitry are operationally responsive to the MCU 1903, with an output from the PA 1919 coupled to the duplexer 1921 or circulator or antenna switch, as known in the art. The PA 1919 also couples to a battery interface and power control unit 1920.

In use, a user of mobile terminal 1901 speaks into the microphone 1911 and his or her voice along with any detected background noise is converted into an analog voltage. The analog voltage is then converted into a digital signal through the Analog to Digital Converter (ADC) 1923. The control unit 1903 routes the digital signal into the DSP 1905 for processing therein, such as speech encoding, channel encoding, encrypting, and interleaving. In one embodiment, the processed voice signals are encoded, by units not separately shown, using a cellular transmission protocol such as enhanced data rates for global evolution (EDGE), general packet radio service (GPRS), global system for mobile communications (GSM), Internet protocol multimedia subsystem (IMS), universal mobile telecommunications system (UMTS), etc., as well as any other suitable wireless medium, e.g., microwave access (WiMAX), Long Term Evolution (LTE) networks, code division multiple access (CDMA), wideband code division multiple access (WCDMA), wireless fidelity (WiFi), satellite, and the like, or any combination thereof.

The encoded signals are then routed to an equalizer 1925 for compensation of any frequency-dependent impairments that occur during transmission though the air such as phase and amplitude distortion. After equalizing the bit stream, the modulator 1927 combines the signal with a RF signal generated in the RF interface 1929. The modulator 1927 generates a sine wave by way of frequency or phase modulation. In order to prepare the signal for transmission, an up-converter 1931 combines the sine wave output from the modulator 1927 with another sine wave generated by a synthesizer 1933 to achieve the desired frequency of transmission. The signal is then sent through a PA 1919 to increase the signal to an appropriate power level. In practical systems, the PA 1919 acts as a variable gain amplifier whose gain is controlled by the DSP 1905 from information received from a network base station. The signal is then filtered within the duplexer 1921 and optionally sent to an antenna coupler 1935 to match impedances to provide maximum power transfer. Finally, the signal is transmitted via antenna 1917 to a local base station. An automatic gain control (AGC) can be supplied to control the gain of the final stages of the receiver. The signals may be forwarded from there to a remote telephone which may be another cellular telephone, any other mobile phone or a land-line connected to a Public Switched Telephone Network (PSTN), or other telephony networks.

Voice signals transmitted to the mobile terminal 1901 are received via antenna 1917 and immediately amplified by a low noise amplifier (LNA) 1937. A down-converter 1939 lowers the carrier frequency while the demodulator 1941 strips away the RF leaving only a digital bit stream. The signal then goes through the equalizer 1925 and is processed by the DSP 1905. A Digital to Analog Converter (DAC) 1943 converts the signal and the resulting output is transmitted to the user through the speaker 1945, all under control of a Main Control Unit (MCU) 1903 which can be implemented as a Central Processing Unit (CPU).

The MCU 1903 receives various signals including input signals from the keyboard 1947. The keyboard 1947 and/or the MCU 1903 in combination with other user input components (e.g., the microphone 1911) comprise a user interface circuitry for managing user input. The MCU 1903 runs a user interface software to facilitate user control of at least some functions of the mobile terminal 1901 to provide providing intelligent processing of contextual information. The MCU 1903 also delivers a display command and a switch command to the display 1907 and to the speech output switching controller, respectively. Further, the MCU 1903 exchanges information with the DSP 1905 and can access an optionally incorporated SIM card 1949 and a memory 1951. In addition, the MCU 1903 executes various control functions required of the terminal. The DSP 1905 may, depending upon the implementation, perform any of a variety of conventional digital processing functions on the voice signals. Additionally, DSP 1905 determines the background noise level of the local environment from the signals detected by microphone 1911 and sets the gain of microphone 1911 to a level selected to compensate for the natural tendency of the user of the mobile terminal 1901.

The CODEC 1913 includes the ADC 1923 and DAC 1943. The memory 1951 stores various data including call incoming tone data and is capable of storing other data including music data received via, e.g., the global Internet. The software module could reside in RAM memory, flash memory, registers, or any other form of writable storage medium known in the art. The memory device 1951 may be, but not limited to, a single memory, CD, DVD, ROM, RAM, EEPROM, optical storage, magnetic disk storage, flash memory storage, or any other non-volatile storage medium capable of storing digital data.

An optionally incorporated SIM card 1949 carries, for instance, important information, such as the cellular phone number, the carrier supplying service, subscription details, and security information. The SIM card 1949 serves primarily to identify the mobile terminal 1901 on a radio network. The card 1949 also contains a memory for storing a personal telephone number registry, text messages, and user specific mobile terminal settings.

While the invention has been described in connection with a number of embodiments and implementations, the invention is not so limited but covers various obvious modifications and equivalent arrangements, which fall within the purview of the appended claims. Although features of the invention are expressed in certain combinations among the claims, it is contemplated that these features can be arranged in any combination and order.

1. A method comprising facilitating a processing of and/or processing (1) data and/or (2) information and/or (3) at least one signal, the (1) data and/or (2) information and/or (3) at least one signal based, at least in part, on the following:
at least one feature based, at least in part, on one or more contextual parameters;
a processing of one or more contextual records to determine whether the at least one feature is a feature anchor based, at least in part, on whether the at least feature is represented above at least one threshold level; and
a processing of the one or more contextual records to determine at least one feature profile for the at least one feature anchor.

2. A method of claim 1, wherein the (1) data and/or (2) information and/or (3) at least one signal are further based, at least in part, on the following:
a tagging of the one or more contextual parameters as being associated with the at least one feature anchor based, at least in part, on the at least one feature.

3. A method of claim 2, wherein the (1) data and/or (2) information and/or (3) at least one signal are further based, at least in part, on the following:
a processing of the tagged one or more contextual parameters to determine one or more related contextual parameters associated with the at least one feature anchor; and
a processing of the one or more related contextual parameters, the at least one feature anchor, or a combination thereof to determine the at least one feature profile.

4. A method of claim 3, wherein the (1) data and/or (2) information and/or (3) at least one signal are further based, at least in part, on the following:
an aggregation of the one or more feature profiles into at least one user profile; and
an association of the at least one user profile with at least one user associated with the one or more contextual records, the one or more contextual parameters, or a combination thereof.

5. A method of claim 1, wherein the (1) data and/or (2) information and/or (3) at least one signal are further based, at least in part, on the following:
an ordering of the at least one feature anchor, the one or more contextual records, the one or more contextual parameters, or a combination thereof based, at least in part, on a chronological order; and
one or more predicted contexts based, at least in part, on the ordering.

6. A method of claim 5, wherein the (1) data and/or (2) information and/or (3) at least one signal are further based, at least in part, on the following:
one or more user interactions associated with one or more device functions, the one or more device functions based, at least in part, on the one or more predicted contexts; and
a processing of the one or more user interactions to determine a delivery method associated with the one more device functions.

7. A method of claim 6, wherein the (1) data and/or (2) information and/or (3) at least one signal are further based, at least in part, on the following:
one or more cues associated with the one or more user interactions with the one or more device functions; and
a processing of the one or more cues to determine the delivery method associated with the one or more device functions.

8. A method of claim 1, wherein the (1) data and/or (2) information and/or (3) at least one signal are further based, at least in part, on the following:
an association of sensor data with the one or more contextual records, the one or more contextual parameters, the at least one feature anchor, or a combination thereof; and
a correlation of the sensor data, the one or more contextual records, the one or more contextual parameters, the at least one feature anchor, or a combination thereof to one or more events; and
a processing of the correlation to determine one or more relationships between the sensor data, the one or more contextual records, the one or more contextual parameters, the at least one feature anchor, or a combination thereof and the one or more events.

9. A method of claim 8, wherein the (1) data and/or (2) information and/or (3) at least one signal are further based, at least in part, on the following:
a prediction of one or more future events, a determination of one or more current events, or a combination thereof based, at least in part, on the one or more relationships.

10. A method of claim 8, wherein the (1) data and/or (2) information and/or (3) at least one signal are further based, at least in part, on the following:
at least one determination of the one or more events based, at least in part, on the one or more events being local to one or more devices associated with the one or more contextual records.

11. An apparatus comprising:
at least one processor; and
at least one memory including computer program code for one or more programs,
the at least one memory and the computer program code configured to, with the at least one processor, cause the apparatus to perform at least the following,
determine at least one feature based, at least in part, on one or more contextual parameters;
process and/or facilitate a processing of one or more contextual records to determine whether the at least one feature is a feature anchor based, at least in part, on whether the at least feature is represented above at least one threshold level; and
process and/or facilitate a processing of the one or more contextual records to determine at least one feature profile for the at least one feature anchor.

12. An apparatus of claim 11, wherein the apparatus is further caused to:
cause, at least in part, a tagging of the one or more contextual parameters as being associated with the at least one feature anchor based, at least in part, on the at least one feature.

13. An apparatus of claim 12, wherein the apparatus is further caused to:
process and/or facilitate a processing of the tagged one or more contextual parameters to determine one or more related contextual parameters associated with the at least one feature anchor; and
process and/or facilitate a processing of the one or more related contextual parameters, the at least one feature anchor, or a combination thereof to determine the at least one feature profile.

14. An apparatus of claim 13, wherein the apparatus is further caused to:
cause, at least in part, an aggregation of the one or more feature profiles into at least one user profile; and
cause, at least in part, an association of the at least one user profile with at least one user associated with the one or more contextual records, the one or more contextual parameters, or a combination thereof.

15. An apparatus of claim 11, wherein the apparatus is further caused to:
cause, at least in part, an ordering of the at least one feature anchor, the one or more contextual records, the one or more contextual parameters, or a combination thereof based, at least in part, on a chronological order; and
determine one or more predicted contexts based, at least in part, on the ordering.

16. An apparatus of claim 15, wherein the apparatus is further caused to:
determine one or more user interactions associated with one or more device functions, the one or more device functions based, at least in part, on the one or more predicted contexts; and
process and/or facilitate a processing of the one or more user interactions to determine a delivery method associated with the one more device functions.

17. An apparatus of claim 16, wherein the apparatus is further caused to:
determine one or more cues associated with the one or more user interactions with the one or more device functions; and
process and/or facilitate a processing of the one or more cues to determine the delivery method associated with the one or more device functions.

18. An apparatus of claim 11, wherein the apparatus is further caused to:
cause, at least in part, an association of sensor data with the one or more contextual records, the one or more contextual parameters, the at least one feature anchor, or a combination thereof; and
cause, at least in part, a correlation of the sensor data, the one or more contextual records, the one or more contextual parameters, the at least one feature anchor, or a combination thereof to one or more events; and
process and/or facilitate a processing of the correlation to determine one or more relationships between the sensor data, the one or more contextual records, the one or more contextual parameters, the at least one feature anchor, or a combination thereof and the one or more events.

19. An apparatus of claim 18, wherein the apparatus is further caused to:
cause, at least in part, a prediction of one or more future events, a determination of one or more current events, or a combination thereof based, at least in part, on the one or more relationships.

20. An apparatus of claim 18, wherein the apparatus is further caused to:
determine the one or more events based, at least in part, on the one or more events being local to one or more devices associated with the one or more contextual records.

21-48. (canceled)
